(19) United States
(12) Patent Application Publication
(10) Pub. No.: US 2022/0190690 A1
(43) Pub. Date: Jun. 16, 2022

(54) Motor Driving Device

(71) Applicant: Rohm Co., Ltd., Kyoto (JP)

(72) Inventors: Kohki Taniguchi, Kyoto (JP); Akira Hashimoto, Kyoto (JP)

(21) Appl. No.: 17/545,817

(22) Filed: Dec. 8, 2021

(30) Foreign Application Priority Data
Dec. 14, 2020 (JP) 2020206438

(51) Int. Cl. H02K 11/215; H02K 11/33; H02P 6/16; H02P 27/08

(52) U.S. Cl. CPC H02K 11/215; H02P 27/08; H02P 6/16; H02K 11/33

(57) ABSTRACT

The present disclosure provides a motor driving device. The motor driving device includes: a control signal generator, identifying a rotor position according to a position detection signal of the rotor of a three-phase motor, and outputting a digital control signal corresponding to the position identified; a DA converter, generating first and second command phase voltages corresponding to two of U, V and W phases by a resistance ladder according to the control signal; a periodic voltage generator, generating a periodic voltage; first and second comparators, generating first and second pulse width modulation (PWM) signals by comparing the first and second command phase voltages and the periodic voltage; and a logic circuit, implementing a two-phase modulation by assigning the first and second PWM signals to any two of the U, V and W phases according to the position detection signal.

### TECHNICAL FIELD

The present disclosure relates to a motor driving device.

### BACKGROUND

FIG. 21 shows a configuration of a motor driving system that drives a three-phase motor by using pulse width modulation (PWM) in related prior art. A motor 1001 is a three-phase brushless motor, and includes stators of coils 1002u, 1002v and 1002w of a U phase, a V phase and a W phase, and a rotor (not shown) including a permanent magnet. In the motor 1001, a position detector 1004 for detecting a position (magnetic pole position) of the rotor is provided. The position detector 1004 includes three Hall elements, and detects the position of the rotor (phase of the rotor) by an electric angle of 60°. A driver integrated circuit (IC) 1010 in FIG. 21 includes a driving control circuit 1020, a pre-driver 1030 and an inversion circuit 1040. The inversion circuit 1040 has half-bridge circuits of three phases.

The driving control circuit 1020 generates driving signals DRVu′, DRVv′ and DRVw′ corresponding to the half-bridge circuits of three phases according to detection signals HALL_u′, HALL_v′ and HALL_w′ indicating detection results of the three Hall elements of the position detector 1004. The pre-driver 1003 switching drives the half-bridge circuits of three phases according to the driving signals DRVu′, DRVv′ and DRVw′, and supplies a voltage obtained by performing PWM on a DC power supply voltage VPWR′ to the coils 1002u, 1002v and 1002w, thereby rotating and driving the motor 1001.

### PRIOR ART DOCUMENT

### Patent Publication

[Patent document 1] Japan Patent Publication No. 2001-37278

### SUMMARY

### Problems to be Solved by the Disclosure

FIG. 22 shows a configuration example of a driving control circuit 1020. A digital/analog (DA) converter 1024 receives a digital control signal CNT′ generated based on the detection signals HALL_u′, HALL_v′ and HALL_w′, converts the control signal CNT′ to an analog voltage, and generates and outputs three command phase voltages supplied to the coils of the U phase, the V phase and the W phase. The DA converter 1024 includes: a resistance ladder 1240 having a series circuit of a plurality of resistors; and switch circuits 1241 to 1243, generating three command phase voltages by capturing at any moment a voltage at any node of the resistance ladder 1240 according to the control signal CNT′. Comparison blocks of comparators 1025_1, 1025 2 and 1025_3 respectively compare the three command phase voltages with a triangle wave voltage. A logic circuit 1026 refers to the detection signals HALL_u′, HALL_v′ and HALL_w′ according to requirements, and generates the driving signals DRVu′, DRVv′ and DRVw′ according to the comparison results of the comparison blocks.

Alternatively, the driving control circuit 1020 may also drive the motor 1001 by a two-phase modulation. In the two-phase modulation, a specific PWM frequency is frequently used to switch half-bridge circuits of two of the U phase, the V phase and the W phase, and the output of the half-bridge of the remaining one phase is fixed to a high level or a low level.

When the two-phase modulation is used, it may be said that the configuration of the driving control circuit 1020 in FIG. 22 is useless, and there is still in need of improvement from the perspective of reducing a circuit size. The reasons for the above will become more apparent in the description below.

It is an object of the present disclosure to provide a motor driving device that is conducive to reducing a circuit size.

### Technical Means for Solving the Problem

A motor driving device of the present disclosure is configured (first configuration) to drive a three-phase motor having coils with a U phase, a V phase and a W phase by a two-phase modulation, the motor driving device including: a control signal generator, identifying a position of a rotor based on a position detection signal of the rotor of the three-phase motor, and outputting a digital control signal according to the position identified; a DA converter, including a resistance ladder having a series circuit of a plurality of resistors, wherein the resistance ladder is used to generate, according to the control signal, analog first and second command phase voltages that represent phase voltages to be supplied to the coils of two of the U, V and W phases; a periodic voltage generator, generating an analog periodic voltage with a voltage value that fluctuates periodically; a first comparator, generating a first PWM signal by comparing the analog first command phase voltage and the analog periodic voltage; a second comparator, generating a second PWM signal by comparing the analog second command phase voltage and the analog periodic voltage; and a logic circuit, implementing the two-phase modulation by assigning the first and second PWM signals to any two of the U, V and W phases according to the position detection signal.

The motor driving device of the first configuration may also be configured as (second configuration): wherein a plurality of voltages are generated at a plurality of nodes in the resistance ladder by applying a predetermined DC voltage to the series circuit, the DA converter includes a first switch circuit connected to the plurality of nodes and a second switch circuit connected to the plurality of nodes, and the first switch circuit generates the first command phase voltage by selecting one of the plurality of voltages according to the control signal, and the second switch circuit generates the second command phase voltage by selecting one of the plurality of voltages according to the control signal.

The motor driving device of the first or the second configuration may also be configured as (third configuration): further comprising an output stage circuit, wherein the logic circuit assigns, according to the position detection signal, the first and second PWM signals to any two of the U, V and W phases as a first switching drive phase and a second switching drive phase, and a fixed signal to one remaining phase as a switching stop phase, and wherein the output stage circuit follows an output signal from the logic circuit according to an assignment result of the logic circuit, and a first switching voltage and a second switching voltage which are based on the first and second PWM signals are supplied to the coils of the first and second switching drive phases, and a fixed voltage is supplied to the coil of the switching stop phase.

The motor driving device of the third configuration may also be configured as (fourth configuration): when the rotor rotates in the two-phase modulation, a first period, a second period, a third period, a fourth period, a fifth period and a sixth period are repeatedly accessed in such order; wherein the first command phase voltage represents a phase voltage to be supplied to the coil of the U phase in the first period and the second period, a phase voltage to be supplied to the coil of the V phase in the third period and the fourth period, and a phase voltage to be supplied to the coil of the W phase in the fifth period and the sixth period; the second command phase voltage represents a phase voltage to be supplied to the coil of the W phase in the second period and the third period, a phase voltage to be supplied to the coil of the U phase in the fourth period and the fifth period, and a phase voltage to be supplied to the coil of the V phase in the sixth period and the first period; and wherein in the logic circuit, the U phase and the V phase are respectively set to be the first and second switching drive phases in the first period, the U phase and the W phase are respectively set to be the first and second switching drive phases in the second period, the V phase and the W phase are respectively set to be the first and second switching drive phases in the third period, the V phase and the U phase are respectively set to be the first and second switching drive phases in the fourth period, the W phase and the U phase are respectively set to be the first and second switching drive phases in the fifth period, and the W phase and the V phase are respectively set to be the first and second switching drive phases in the sixth period.

The motor driving device of the fourth configuration may also be configured as (fifth configuration): the position detection signal includes a first detection signal, a second detection signal and a third detection signal, and a phase of the rotor representing the position of the rotor is specified by the first to third detection signals in increments of an electric angle of 60°, and each of the first to sixth periods has a length corresponding to a change in the phase of the rotor by an electric angle of 120°; and the logic circuit generates, according to the first to third detection signals, an internal signal whose signal level changes each time when the phase of the rotor changes by an electric angle of 120°, when the signal level of the internal signal changes, the phase to be assigned to the first and second PWM signals is switched between the U phase, the V phase and the W phase, and the phase to be assigned is determined according to the first to third detection signals.

The motor driving device of the fifth configuration may also be configured as (sixth configuration): an advance angle control is executable in the motor driving device, and the logic circuit implements the advance angle control by providing a phase difference corresponding to an advance angle value between the first to third detection signals and the internal signal.

The motor driving device of the fifth or sixth configuration may also be configured as (seventh configuration): each of the first to third detection signals is a binary signal.

The motor driving device of the second configuration may also be configured as (eighth configuration): further including: a reference voltage generator to which a power supply voltage is an input, outputting a signal for determining an amplitude of the analog periodic voltage to the periodic voltage generator.

The motor driving device of the eighth configuration may also be configured as (ninth configuration): the reference voltage generator outputs the predetermined DC voltage applied to the resistance ladder.

The motor driving device of the ninth configuration may also be configured as (tenth configuration): the reference voltage generator outputs a first DC voltage and a second DC voltage lower than the first DC voltage, wherein the predetermined DC voltage is a difference between the first DC voltage and the second DC voltage.

### Effects of the Disclosure

According to the present disclosure, a motor driving device that is conducive to reducing a circuit size is provided.

### BRIEF DESCRIPTION OF THE DRAWINGS

FIG. 1 is a schematic diagram of a motor according to an embodiment of the present disclosure;

FIG. 2 is a diagram representing a relation between magnetic poles of a rotor and three position detection units according to an embodiment of the present disclosure;

FIG. 3 is a diagram representing a relation between output signals of three position detection units and a position (phase) of a rotor according to an embodiment of the present disclosure;

FIG. 4 is a structural diagram of a motor driving system according to an embodiment of the present disclosure;

FIG. 5 is a three-dimensional diagram of the appearance of a driver IC according to an embodiment of the present disclosure;

FIG. 6 is a waveform diagram of phase voltages of U phase, V phase and W phase during a two-phase modulation according to an embodiment of the present disclosure;

FIG. 7 is a waveform diagram of three interphase voltages during a two-phase modulation according to an embodiment of the present disclosure;

FIG. 8 is a waveform diagram of respective target phase voltages during a two-phase modulation according to an embodiment of the present disclosure;

FIG. 9 is a structural diagram of a driving control circuit according to an embodiment of the present disclosure;

FIG. 10 is a waveform diagram of a periodic voltage generated by a periodic voltage generator in FIG. 9;

FIG. 11 is a waveform diagram of two command phase voltages output from a DA converter according to an embodiment of the present disclosure;

FIGS. 12(a) and 12(b) are diagrams of relations between target phase voltages of U phase, V phase and W phase and two command phase voltages according to an embodiment of the present disclosure;

FIG. 13 is a waveform diagram of two PWM signals obtained by performing PWM on two command phase voltages according to an embodiment of the present disclosure;

FIG. 14 is a waveform diagram of driving signals of U phase, V phase and W phase generated by the driving control circuit in FIG. 9 according to an embodiment of the present disclosure;

FIGS. 15 is a diagram of a relation between two PWM signals and driving signals of U phase, V phase and W phase according to an embodiment of the present disclosure;

FIG. 16 is an internal structural diagram of a DA converter according to an embodiment of the present disclosure;

FIG. 17 is a diagram for illustrating multiple voltages generated by a resistance ladder in FIG. 16;

FIG. 18 is a circuit diagram of a driving signal generator according to a first embodiment affiliated with an embodiment of the present disclosure;

FIG. 19 is a timing diagram of operations of a driving signal generator according to the first embodiment affiliated with an embodiment of the present disclosure;

FIG. 20 is a timing diagram of operations of a driving signal generator according to a second embodiment affiliated with an embodiment of the present disclosure;

FIG. 21 is a structural diagram of a motor driving system of related prior art; and

FIG. 22 is a diagram of a structure for generating driving signals of U phase, V phase and W phase of related prior art.

### DETAILED DESCRIPTION OF THE EMBODIMENTS

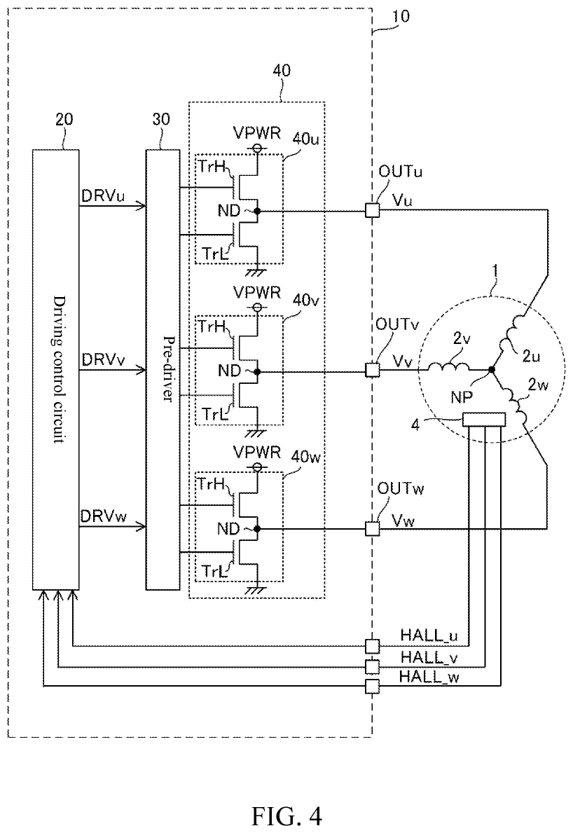

Details of examples of the embodiments of the present disclosure are given with the accompanying drawings below. In the reference drawings, the same parts are denoted by the same numerals or symbols, and repeated description related to the same parts is in principle omitted. Further, to keep the description of the present application simple, the names of information, signals, physical quantities, elements or parts corresponding to the numerals or symbols are sometimes omitted or simply depicted by denoting numerals or symbols of reference information, signals, physical quantities, elements or parts. For example, a high-side transistor (referring to FIG. 4) referenced by “TrH” to be described shortly is sometimes expressed as a high-side transistor TrH, or is sometimes expressed in short as a transistor TrH, and all these cases refer to the same part.

Some terms and definitions of configurations used in the description of the embodiments of the present disclosure are first explained below. The term “IC” refers to an integrated circuit. A “line” refers to a wire for propagating or applying an electrical signal. The so-called “ground” refers to a reference conductive portion having a reference voltage of 0 V potential or the 0 V potential itself. The “reference conductive portion” is formed by a conductor such as a metal. The 0 V potential is sometimes referred to as a ground potential. In the embodiments of the present disclosure, a voltage expressed without a specifically set reference represents a potential observed from a ground aspect.

For any concerned signal or voltage, the “level” refers to the level of a potential, and a high level has a potential higher than that of a low level. For any concerned signal or voltage, the signal or voltage at a high level means that the level of the signal or voltage is at a high level, and the signal or voltage at a low level means that the level of the signal or voltage is at a low level. The level regarding a signal is sometimes expressed as a signal level, and the level regarding a voltage is sometimes expressed as a voltage level. For any concerned signal, an inverted signal of the signal is at a low level when the signal is at a high level, and an inverted signal of the signal is at a high level when the signal is at a low level.

For any concerned signal or voltage, switching from a low level to a high level is referred to as an upper edge (or a rising edge), and a moment of switching from a low level to a high level is referred to as an upper edge moment (or a rising edge moment). For any concerned signal or voltage, switching from a high level to a low level is referred to as a lower edge (or a falling edge), and a moment of switching from a high level to a low level is referred to as a lower edge moment (or a falling edge moment).

For any transistor formed as a field-effect transistor (FET) including a metal-oxide-semiconductor field-effect transistor (MOSFET), an “on state” refers to a state of conduction between the drain and the source of the transistor, and an “off state” refers to a state of non-conduction (a disconnected state) between the drain and the source of the transistor. The same applies to non-FET transistors. Unless otherwise specified, a MOSFET is interpreted as an enhanced MOSFET. MOSFET is an abbreviation of metal-oxide-semiconductor field-effect transistor.

More than one FET may be configured as any switch, two terminals of the switch is conducted when the switch is in an on state, and on the other hand, the two terminals of the switch is non-conducted when the switch is in an off state. In the description below, for any transistor or switch, the “on state” and the “off state” may also be expressed simply as “on” and “off”.

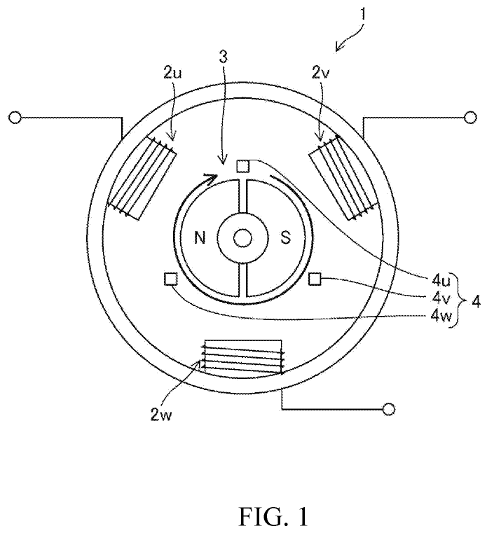

FIG. 1 shows a schematic diagram of a motor 1 according to an embodiment of the present disclosure. The motor 1 is a three-phase brushless motor, and includes stators of armature windings of three phases, and a rotor 3 including a permanent magnet. The armature windings of three phases include an armature winding of U phase, i.e., a coil 2u, an armature winding of V phase, i.e., a coil 2v, and an armature winding of W phase, i.e., a coil 2w. Moreover, in this embodiment, a rotation of the motor 1 specifically refers to a rotation of the rotor 3. In addition, the direction of the rotation of the rotor 3 in this embodiment is set to be fixed. Further, the number of poles of the motor 1 is arbitrary.

In the motor 1, a position detector 4 for detecting a position of the rotor 3 is provided. The position detector 4 includes a position detection unit 4u for the U phase, a position detection unit 4v of the V phase, and a position detection unit 4w for the W phase. Each position detection unit includes a Hall element, and a signal processing circuit that amplifies and binarizes an output signal of the Hall element. Each position detection unit may be a Hall IC formed by means of an integrated circuit. Herein, it is considered that the position detector 4 is disposed in the motor 1, an approach of separately arranging the position detector 4 and the motor 1 may also be adopted. Moreover, each position detection unit may be configured to include a Hall element, but to exclude a signal processing circuit that amplifies and binarizes an output signal of the Hall element. In this case, the signal processing circuit is disposed in a device (referring to FIG. 4, a driver IC 10 to be described shortly) that receives an output signal of the Hall element. In the description below, it is assumed that each position detection unit includes a signal processing circuit.

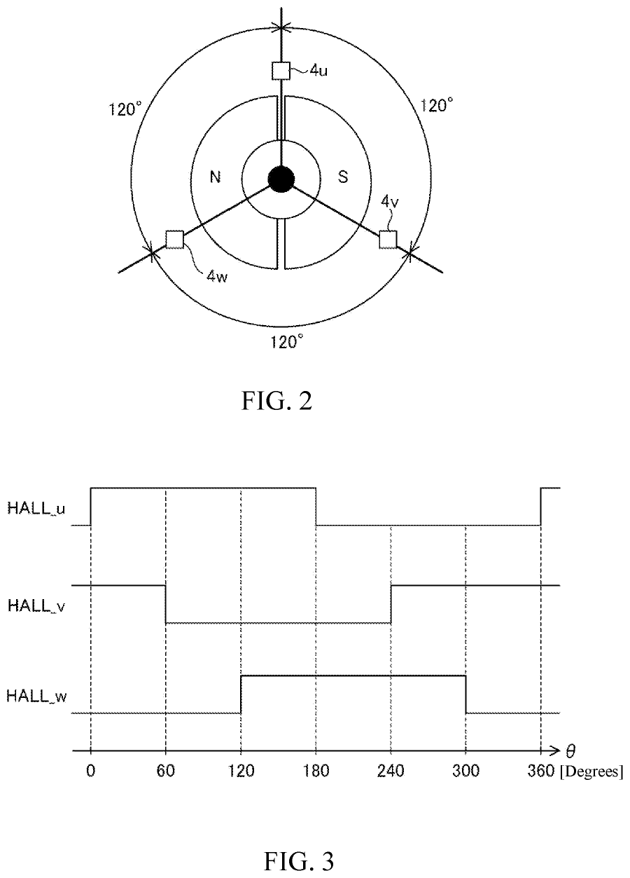

The position of the rotor 3 detected by the position detector 4 is a magnetic pole position of the rotor 3, and indicates a phase of the rotor 3 when the rotor 3 is in a rotating motion. In this embodiment, unless otherwise specified, the phase of the rotor 3 refers to a phase of an electric angle, and an angle such as 60° or 120° refers to an electric angle. As shown in FIG. 2, the position detection units 4u, 4v and 4w are arranged at positions shifted by an electric angle of 120° from one another. Moreover, the phase of the rotor 3 is sometimes denoted by 0.

FIG. 3 shows waveforms of detection signals HALL_u, HALL_v and HALL_w. The position detection unit 4u outputs a signal corresponding to the direction of the magnetic field applied from the permanent magnet of the rotor 3 to the Hall element (the Hall element in the unit 4u) as the detection signal HALL_u. The position detection unit 4v outputs a signal corresponding to the direction of the magnetic field applied from the permanent magnet of the rotor 3 to the Hall element (the Hall element in the unit 4v) as the detection signal HALL_v. The position detection unit 4w outputs a signal corresponding to the direction of the magnetic field applied from the permanent magnet of the rotor 3 to the Hall element (the Hall element in the unit 4w) as the detection signal HALL_w. Each detection signal is a binary signal that having a signal level of either a high level or a low level. That is to say, the phase θ of the rotor 3 is detected at an increment of 180° by the position detection units. In addition, as described above, since the position detection units 4u, 4v and 4w are arranged as being shifted by an electric angle of 120° from one another, the phase 0 of the rotor 3 is detected at an increment of an electric angle of 60° by the units 4u, 4v and 4w (that is to say, 60° is set as the minimum unit for the detection).

Herein, when the rotor 3 rotates in a predetermined direction, the phase θ of the rotor 3 when an upper edge is generated in the detection signal HALL _u is set as 0°, and the phase θ of the rotor 3 when a lower edge is generated in the detection signal HALL_u is set as 180°. Thus, the phase θ of the rotor 3 when an upper edge is generated in the detection signal HALL_v is 240°, and the phase θ of the rotor 3 when a lower edge is generated in the detection signal HALL_v is 60°; the phase θ of the rotor 3 when an upper edge is generated in the detection signal HALL_w is 120°, and the phase θ of the rotor 3 when a lower edge is generated in the detection signal HALL_w is 300°.

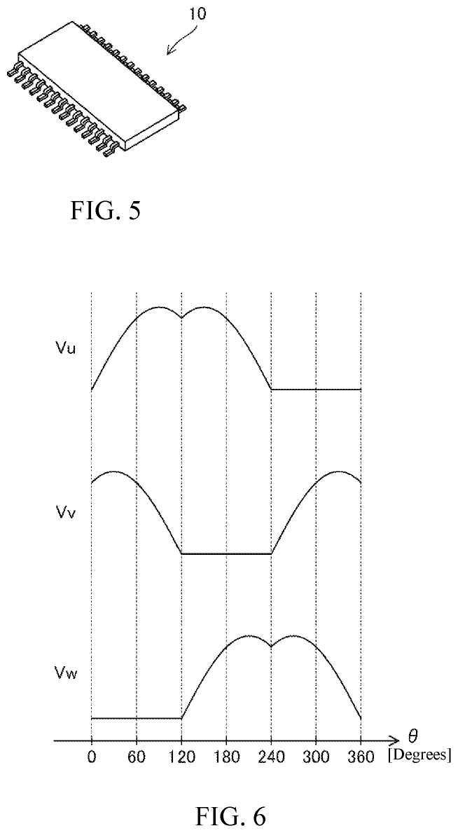

FIG. 4 shows a structural diagram of a motor driving system having the motor 1. The motor driving system is configured to include the motor 1, and a motor driving device exemplified by the driver IC 10. The drawing of the rotor 3 is omitted in FIG. 4. The driver IC 10 is an electronic component formed by packaging a semiconductor IC into a frame (package) made of resin, as shown in FIG. 5. Moreover, the pin count (the number of external terminals) of the driver IC 10 in FIG. 5 and the type of the frame of the driver IC 10 shown in FIG. 5 are only examples, and the pin count and the type of the frame of the driver IC 10 may be arbitrary.

The external terminals of the driving IC 10 include terminals OUTu, OUTv and OUTw. In the motor 1, the coils 2u and 2v are in a star connection with the coil 2w. One terminal of the coil 2u, one terminal of the coil 2v, and one terminal of the coil 2w are respectively connected to the external terminals OUTu, OUTv and OUTw, and respective other terminals of the coils 2u and 2v and the coil 2w are commonly connected to a neutral point NP. The external terminals OUTu, OUTv and OUTw may also be referred to as output terminals.

The driver IC 10 includes a driving control circuit 20, a pre-driver 30 and an inversion circuit 40. The inversion circuit 40 includes a half-bridge circuit 40u for the U phase, a half-bridge circuit 40v for the V phase, and a half-bridge circuit 40w for the W phase.

Each of the half-bridge circuits 40u, 40v and 40w includes a high-side transistor TrH and a low-side transistor TrL connected in series between a line that applies a power supply voltage VPWR and the ground. The transistors TrH and TrL are configured as N-channel metal-oxide semiconductor field-effect transistors (MOSFETs). The power supply voltage VPWR is a predetermined positive direct-current (DC) voltage (for example, 12 V).

More specifically, in each of the half-bridge circuits 40u, 40v and 40w, the drain of the transistor TrH is connected to a first power supply terminal that applies the power supply voltage VPWR and receives the power supply voltage VPWR supplied, the source of the transistor TrH and the drain of the transistor TrL are commonly connected by a node ND, and the source of the transistor TrL is connected to the ground that functions as a second power supply terminal. Moreover, the source of each transistor TrL may also be connected to the ground via a resistor used for abnormal current detection (in FIG. 1, the drawing of the resistor for abnormal current detection is omitted). The nodes ND of the half-bridge circuits 40u, 40v and 40w are respectively connected to the output terminals OUTu, OUTv and OUTw. Thus, the nodes ND of the half-bridge circuits 40u, 40v and 40w are respectively connected to respective one ends of the coils 2u, 2v and 2w via the output terminals OUTu, OUTv and OUTw. Vu, Vv, Vw are used to represent the voltages that are applied to the output terminals OUTu, OUTv, OUTw and are equivalent to the voltages of respective one ends of the coil 2u, 2v and 2w, and the voltage Vu, Vv, or Vw is referred to as a phase voltage or a terminal voltage.

The detection signals HALL_u, HALL _u and HALL_w output from the position detector 4 are input to the driving control circuit 20 via the three external terminals provided at the driver IC 10. The driving control circuit 20 generates and outputs a driving signal DRVu corresponding to the half-bridge circuit 40u, a driving signal DRVv corresponding to the half-bridge circuit 40v and a driving signal DRVw corresponding to the half-bridge circuit 40w according to the detection signals HALL_u, HALL _v and HALL_w. For example, a torque command signal that specifies a torque to be generated by the motor 1 may be assigned to the driving control circuit 20, and in this case, the driving control circuit 20 generates the driving signals DRVu, DRVv and DRVw in order to generate the torque specified by the torque command signal by the motor 1. For example, a rotational speed command signal that specifies a rotational speed to be generated by the motor 1 may be assigned to the driving control circuit 20, and in this case, the driving control circuit 20 generates the driving signals DRVu, DRVv and DRVw in order to generate the rotational speed specified by the rotational speed command signal by the motor 1. Each of the driving signals DRVu, DRVv and DRVw is a binary signal, and has a value of “1” or “0”.

The pre-driver 30 controls the gate potential of each transistor in the half-bridge circuits 40u, 40v and 40w according to the driving signals DRVu, DRVv and DRVw, so as to control the state of each half-bridge circuit. In any one of the half-bridge circuits 40u, 40v and 40w, that is, a target half-bridge circuit, a state in which the transistor TrH is turned on and the transistor TrL is turned off is referred to as an output high state, and a state in which the transistor TrH is turned off and the transistor TrL is turned on is referred to as an output low state. Assuming that the on resistances of the transistors TrH and TrL are zero, for example, the power supply voltage VPWR is applied to the output terminal OUTu via the high-side transistor TrH if the half-bridge circuit 40u is in the output high state, and the ground potential is applied to the output terminal OUTu (with a transitional state disregarded) via the low-side transistor TrL if the half-bridge circuit 40u is in the output low state. The same applies to the half-bridge circuits 40v and 40w.

The pre-driver 30 performs, by means of having the half-bridge circuit 40u in the output high state in a period in which the driving signal DRVu is in a value of “1” and having the half-bridge circuit 40u in the output low state in a period in which the driving signal DRVu is in a value of “0”, driving of the U phase that controls the gate potentials of the transistors TrH and TrL of the half-bridge circuit 40u. Similarly, the pre-driver 30 performs, by means of having the half-bridge circuit 40v in the output high state in a period in which the driving signal DRVv is in a value of “1” and having the half-bridge circuit 40v in the output low state in a period in which the driving signal DRVv is in a value of “0”, driving of the V phase that controls the gate potentials of the transistors TrH and TrL of the half-bridge circuit 40v. Similarly, the pre-driver 30 performs, by means of having the half-bridge circuit 40w in the output high state in a period in which the driving signal DRVw is in a value of “1” and having the half-bridge circuit 40w in the output low state in a period in which the driving signal DRVw is in a value of “0”, driving of the W phase that controls the gate potentials of the transistors TrH and TrL of the half-bridge circuit 40w.

The driving control circuit 20 can output PWM signal as the driving signals DRVu, DRVv or DRVw. PWM is an abbreviation of pulse width modulation. The PWM signal is a binary signal having a specific PWM frequency, and alternates between the values “1” and “0”. The driving signal (DRVu, DRVv or DRVw) set as a PWM signal is a binary signal with a variable pulse width. The pulse width of a PWM signal refers to the length of a period in which the PWM signal is in a value of “1” in each cycle of the PWM signal. The same applies to the driving signal (DRVu, DRVv or DRVw) set as a PWM signal.

When the driving signal DRVu is a PWM signal, PWM is performed on the power supply voltage VPWR according to the driving signal DRVu by the half-bridge circuit 40u, and a voltage obtained from the PWM is used as a phase voltage Vu and applied to one terminal of the coil 2u. The phase voltage Vu at this point in time is a switching voltage (square wave voltage), and has a potential of the power supply voltage VPWR in a period in which the driving signal DRVu is in a value of “1” and a potential of the ground in a period in which the driving voltage DRVu is in a value of “0” (with the transitional state disregarded). When the driving signal DRVv is a PWM signal, PWM is performed on the power supply voltage VPWR according to the driving signal DRVv by the half-bridge circuit 40v, and a voltage obtained from the PWM is used as a phase voltage Vv and applied to one terminal of the coil 2v. The phase voltage Vv at this point in time is a switching voltage (square wave voltage), and has a potential of the power supply voltage VPWR in a period in which the driving signal DRVv is in a value of “1” and a potential of the ground in a period in which the driving signal DRVv is in a value of “0” (with the transitional state disregarded). When the driving signal DRVw is a PWM signal, PWM is performed on the power supply voltage VPWR according to the driving signal DRVw by the half-bridge circuit 40w, and a voltage obtained from the PWM is used as a phase voltage Vw and applied to one terminal of the coil 2w. The phase voltage Vw at this point in time is a switching voltage (square wave voltage), and has a potential of the power supply voltage VPWR in a period in which the driving signal DRVw is in a value of “1” and a potential of the ground in a period in which the driving signal DRVw is in a value of “0” (with the transitional state disregarded).

The phase voltages Vu, Vv and Vw based on the driving signals DRVu, DRVv and DRVv formed are output to output stage circuits of the coils 2u, 2v and 2w by the pre-driver 30 and the inversion circuit 40. Moreover, in this embodiment, it is assumed that the inversion circuit 40 is built-in the driver IC 10; however, the inversion circuit 40 may also be a circuit arranged outside the driver IC 10. Apart from the inversion circuit 40, the pre-driver 30 may also be arranged outside the driver IC 10.

The driver IC 10 can drive the motor 1 by a two-phase modulation. During the two-phase modulation, in a driving period of the motor 1, two of the driving signals DRVu, DRVv and DRVw are always set as PWM signals, and the value of the one remaining driving signal is fixed at “0”. In other words, during the two-phase modulation, in the driving period of the motor 1, the half-bridge circuits of two of the U phase, the V phase and the W phase are always switched by the PWM frequency according to the PWM signal , and the half-bridge circuit of the one remaining phase is fixed at an output low state.

FIG. 6 shows waveforms of the phase voltages Vu, Vv and Vw during a two-phase modulation performed by the driver IC 10. When the driving signal DRVu is a PWM signal, the phase voltage Vu in fact undergoes PWM with a period that is in fact sufficiently short compared to the period of the phase voltage Vu; however, an average of the phase voltage Vu is shown in FIG. 6. The average herein refers to an average relative to a PWM period (that is, a reciprocal of the PWM frequency). The same applies to the phase voltages Vv and Vw. During the two-phase modulation in FIG. 6, the phase voltage Vu (strictly speaking, the average voltage of the phase voltage Vu) is a positive voltage in a period in which the phase θ of the rotor 3 satisfies an inequality equation “0°<θ<240°”, and is 0 V outside this period. During the two-phase modulation in FIG. 6, the phase voltage Vv (strictly speaking, the average voltage of the phase voltage Vv) is a positive voltage in a period in which the phase θ of the rotor 3 satisfies an inequality equation “0°<θ<120°” or “240°<θ<360°”, and is 0 V outside this period. During the two-phase modulation in FIG. 6, the phase voltage Vw (strictly speaking, the average voltage of the phase voltage Vw) is a positive voltage in a period in which the phase θ of the rotor 3 satisfies an inequality equation “120°<θ<360°”, and is 0 V outside this period.

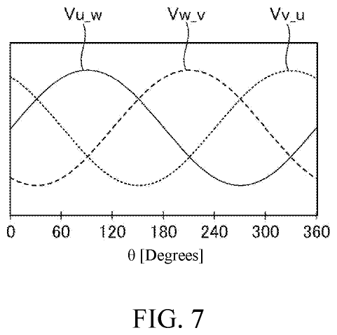

FIG. 7 shows a waveform diagram of three interphase voltages during a two-phase modulation. The three interphase voltages include an interphase voltage Vu_w of the phase voltage Vu when observed from the phase voltage Vw, an interphase voltage Vw_v of the phase voltage Vw when observed from the phase voltage Vv, and an interphase voltage Vv_u of the phase voltage Vv when observed from the phase voltage Vu. The interphase voltage Vu_w in fact undergoes PWM with a period that is in fact sufficiently short compared to the period of the interphase voltage Vu_w; however, an average of the interphase voltage Vu_w is shown in FIG. 7. The average herein refers to an average relative to a PWM period (that is, a reciprocal of the PWM frequency). The same applies to the interphase voltage Vw_v and the interphase voltage Vv_u. During the two-phase modulation, the respective average voltages of the interphase voltages Vu_w, Vw_v and Vv_u become sine wave voltages (voltages having waveforms of sine wave waveforms), and the phases of the interphase voltages Vu_w, Vw_v and Vv_u are shifted by an electric angle of 120° from one another. In the description below, the term “three interphase voltages” refer to the interphase voltages Vu_w, Vw_v and Vv_u.

A phase in which corresponding driving signals in the U phase, the V phase and the W phase are set to a PWM signal is referred to as a switching drive phase. Thus, when the U phase is the switching drive phase, the corresponding driving signal DRVu is set as a PWM signal, and a voltage obtained by performing PWM on the power supply voltage VPWR according to the driving signal DRVu is used as the phase voltage Vu applied to one terminal of the coil 2u. Similarly, when the V phase is the switching drive phase, the corresponding driving signal DRVv is set as a PWM signal, and a voltage obtained by performing PWM on the power supply voltage VPWR according to the driving signal DRVv is used as the phase voltage Vv applied to one terminal of the coil 2v. The same applies when the W phase is the switching drive phase. A phase in which the values of the corresponding driving signals in the U phase, the V phase and the W phase are fixed at “0” is referred to as a switching stop phase. Thus, when the U phase is the switching stop phase, the half-bridge circuit 40u is fixed at the output low state by fixing the value of the corresponding driving signal DRVu at “0”, so as to fix the phase voltage Vu at 0 V. Similarly, when the V phase is the switching stop phase, the half-bridge circuit 40v is fixed at the output low state by fixing the value of the corresponding driving signal DRVv at “0”, so as to fix the phase voltage Vv at 0 V. The same applies when the W phase is the switching stop phase.

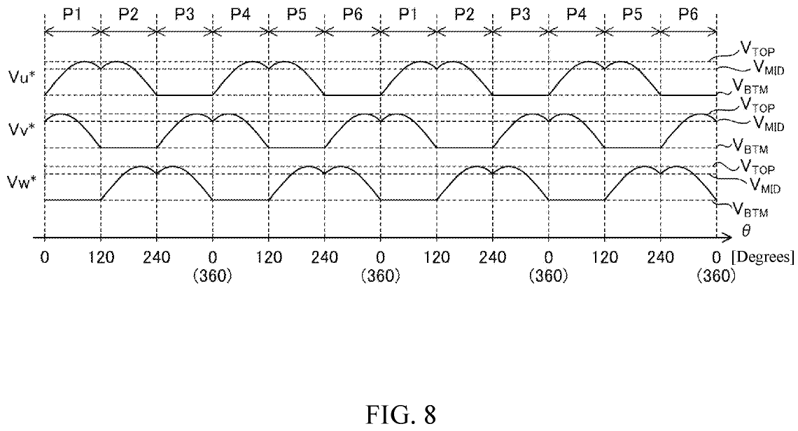

FIG. 8 shows waveforms of target phase voltages Vu*, Vv* and Vw* of multiple periods. The target phase voltages Vu*, Vv* and Vw are targets of the phase voltages Vu, Vv and Vw to be respectively supplied to the coils 2u, 2v and 2w (that is, voltages to be applied to the output terminals OUTu, OUTv and OUTw) in order to set the three interphase voltages to sine wave voltages by the two-phase modulation. However, the target phase voltages Vu*, Vv* and Vw are voltages that have not yet undergone PWM. Thus, strictly speaking, the target phase voltage Vu* represents the target of an average voltage of the phase voltage Vu to be supplied to the coil 2u in order to set the three interphase voltages to sine wave voltages by the two-phase modulation, the target phase voltage Vv* represents the target of an average voltage of the phase voltage Vv to be supplied to the coil 2v in order to set the three interphase voltages to sine wave voltages by the two-phase modulation, and the target phase voltage Vw* represents the target of an average voltage of the phase voltage Vw to be supplied to the coil 2w in order to set the three interphase voltages to sine wave voltages by the two-phase modulation.

Phases of the target phase voltages Vu*, Vv* and Vw* differ by an electric angle of 120° from one another. If the phase differences of the phases are overlooked, the target phase voltages Vu*, Vv* and Vw* have the same waveforms as one another. Each of the target phase voltages Vu*, Vv* and Vw* fluctuates from a minimum voltage V_{BTM} to a maximum voltage V_{TOP} during the rotation of the rotor 3, and is kept consistent with an intermediate voltage V_{MID} during the fluctuation. Herein, “V_{BTM}<V_{MID}<V_{TOP}”. The minimum voltage V_{BTM} coincides with the ground potential.

The entire period in which the two-phase modulation is performed is categorized into periods P1 to P6. In each of the period P1 and the period P4, the U phase and the V phase are set to be switching drive phases. In each of the period P2 and the period P5, the U phase and the W phase are set to be switching drive phases. In each of the period P3 and the period P6, the V phase and the W phase are set to be switching drive phases. Each of the first to sixth periods P1 to P6 has a length corresponding to a change in the phase θ of the rotor 3 by an electric angle of 120°. When the rotor 3 rotates in a fixed direction in the two-phase modulation, the periods P1, P2, P3, P4, P5 and P6 are repeatedly accessed in such order. In the periods P1 to P6, there is not any gap between any two adjacent periods. That is to say, for example, an ending moment of the period P1 coincides with a starting moment of the period P2, and an ending moment of the period P2 coincides with a starting moment of the period P3. Moreover, an ending moment of the period P6 before which the periods P1 to P5 have elapsed coincides with the starting moment of a new period P1. In FIG. 8, the periods P1 and P4 correspond to a period in which “0°≤θ≤120° ” is satisfied, the periods P2 and P5 correspond to a period in which “120°≤θ=240°” is satisfied, and the periods P3 and P6 correspond to a period in which “240°≤θ≤360°” is satisfied (also referring to FIG. 6).

The change in the target phase voltage Vu* during the rotation the rotor 3 in a fixed direction by the two-phase modulation is described in brief below. At the starting moment of the period P1, “Vu*=V_{BTM}”. Once the phase θ of the rotor 3 in the period P1 has changed and the target phase voltage Vu* has monotonically increased from the minimum voltage V_{BTM} to “Vu*=V_{TOP}”, the change in the target phase voltage Vu* is switched to monotonically decreasing, and “Vu*=V_{MID}” at the ending moment of the period P1. At the starting moment of the period P2, “Vu*=V_{BTM}”. At the starting moment of the period P2, “Vu*=V_{MID}”. Once the phase θ of the rotor 3 in the period P2 has changed and the target phase voltage Vu* has monotonically increased from the intermediate voltage V_{MID} to “Vu*=V_{TOP}”, the change in the target phase Vu* is switched to monotonically decreasing, and “Vu*=V_{BTM}” at the ending moment of the period P2. “Vu^{*}=V_{BTM}” is maintained throughout the entire period P3. Behaviors of the target phase voltage Vu* in the periods P4, P5 and P6 are respectively the same as the behaviors of the target phase voltage Vu* in the periods P1, P2 and P3.

The target phase voltage Vw* is obtained only by delaying the phase θ of the rotor 3 by an electric angle of 120° by the target phase voltage Vu*. Thus, the behaviors of the target phase voltage Vw* in the periods P2, P3 and P4 are respectively the same as the behaviors of the target phase voltage Vu* in the periods P1, P2 and P3, and the behaviors of the target phase voltage Vw* in the periods P5, P6 and P1 are the same as the behaviors of the target phase voltage Vu* in the periods P4, P5 and P6. The target phase voltage Vv* is obtained only by delaying the phase θ of the rotor 3 by an electric angle of 240° by the target phase voltage Vu*. Thus, the behaviors of the target phase voltage Vv* in the periods P3, P4 and P5 are respectively the same as the behaviors of the target phase voltage Vu* in the periods P1, P2 and P3, and the behaviors of the target phase voltage Vv* in the periods P6, P1 and P2 are the same as the behaviors of the target phase voltage Vu* in the periods P4, P5 and P6.

When the two-phase modulation is performed, because one phase needs to stop switching, the capability of generating PWM signals of only two phases at any moment is sufficient. That is to say, if a circuit that generates PWM signals of only two phases is arranged in the driving control circuit 20, and the PWM signals of the two phases are assigned to the driving signals DRVu, DRVv and DRVw of three phases according to the detection signals HALL_u, HALL _v and HALL_w, the circuit of one phase can be omitted. A configuration of a circuit implementing the omission of one phase is described below.

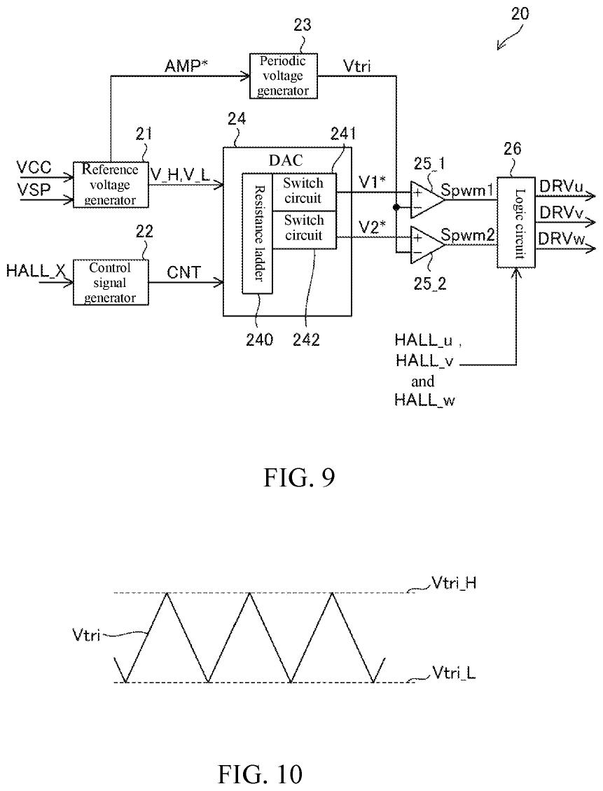

FIG. 9 shows a configuration of a circuit implementing the omission of one phase, that is, a structural diagram of a driving control circuit 20 driving the motor 1 by a two-phase modulation. The driving control circuit 20 in FIG.9 includes a reference voltage generator 21, a control signal generator 22, a periodic voltage generator 23, a DA converter 24, comparators 25_1 and 25_2, and a logic circuit 26.

A power supply voltage VCC and a control voltage VSP are supplied to the reference voltage generator 21. The reference voltage generator 21 outputs an amplitude command signal AMP* that determines an amplitude of a voltage Vtri generated by the periodic voltage generator 23 to the periodic voltage generator 23. Moreover, the reference voltage generator 21 sets voltages V_H and V_L according to the control voltage VSP, and outputs the voltages V_H and V_L to the DA converter 24. A voltage difference (V_H-V_L) between the voltages V_H and V_L is used as a predetermined DC current applied to a resistance ladder 240 in the DA converter 24. The voltages V_H and V_L are DC voltages that satisfy “V_H>V_L”. The voltage V_H is a voltage set to be less than the power supply voltage VCC according to the control voltage VSP. The voltage V_L may be 0 V, or may have a positive voltage value. In addition, the power supply voltage VCC may also be used as a driving voltage to drive the elements in the driving control circuit 20. The power supply voltage VCC is supplied to the driver IC 10 from the outside of the driver IC 10. Alternatively, the power supply voltage VCC is generated in the driver IC 10 based on a DC voltage (for example, the voltage VPWR) supplied to the driver IC 10 from the outside of the driver IC 10.

The control signal generator 22 receives an input of a detection signal HALL_X, and generates and outputs a digital control signal CNT according to the detection signal HALL_X. The detection signal HALL_X is any one of the detection signals HALL_u, HALL_v and HALL_w.

The control signal generator 22 identifies a current position of the rotor 3 (that is, the phase θ) according to the detection signal HALL X, and outputs a control signal CNT corresponding to the position of the rotor 3 identified (that is, the phase θ). More specifically, for example, when the detection signal HALL X is the detection signal HALL_u, a rotation period (equivalent to a length of a period for the phase θ to change by)360° of the rotor 3 is detected according to a time difference between two adjacent upper edges of the detection signal HALL_u, and the phase θ of the current moment is identified according to an elapsed time from an upper edge moment of the detection signal HALL_u to the current moment in each period of the detection signal HALL_u. A value of an electric angle of the identified phase θ may be set to a digital value of the control signal CNT. However, the control signal CNT may be an arbitrary digital value corresponding to the identified phase θ.

Moreover, the control signal generator 22 may also generate and output the control signal CNT according to any two of the detection signals HALL_u, HALL_v and HALL_w, or according to all three detection signals.

The periodic voltage generator 23 generates and outputs the voltage Vtri having a voltage value that periodically fluctuates. A frequency of the voltage Vtri is equivalent to the PWM frequency. Herein, as shown in FIG. 10, the voltage Vtri is set as a triangle wave voltage. That is to say, in each period of the voltage Vtri, using 1/2 of the time of the period of the voltage Vtri, the voltage Vtri monotonically increases from a predetermined lower voltage limit Vtri_L to a predetermined upper voltage limit Vtri H, and then using the remaining 1/2 of the time of the period of the voltage Vtri, the voltage Vtri monotonically decreases from the predetermined upper voltage limit Vtri H to the predetermined lower voltage limit Vtri_L. An amplitude of the voltage Vtri is accorded with the amplitude command signal AMP* from the reference voltage generator 21. Moreover, the voltage Vtri may also be set as a sawtooth voltage.

The DA converter 24 is a digital/analog converter that converts a digital voltage signal, that is, the control signal CNT, to an analog voltage signal. The DA converter 24 generates two analog voltage signals by such conversion. The two analog voltage signals are generated to specify two phase voltages (to be referred to as command phase voltages below) to be supplied to two coils in two switching drive phases in order for implementing the two-phase modulation. One of the command phase voltages is referenced by a denotation V1* and the other command phase voltage is referenced by a denotation V2*. The command phase voltage V1* represents an analog voltage to be supplied to the terminal (any one of OUTu, OUTv and OUTw) of the coil in a first switching drive phase in order to set the three interphase voltages (strictly speaking, the average voltage of each of the three interphase voltages) to sine wave voltages by the two-phase modulation. The command phase voltage V2* represents an analog voltage to be supplied to the terminal (any one of OUTu, OUTv and OUTw) of the coil in a second switching drive phase in order to set the three interphase voltages (strictly speaking, the average voltage of each of the three interphase voltages) to sine wave voltages by the two-phase modulation. Moreover, the command phase voltages V1* and V2* are voltages before PWM is performed.

The DA converter 24 includes: a resistance ladder 240 having a series circuit of a plurality of resistors; and switch circuits 241 and 242, generating the command phase voltages V1* and V2* by capturing at any moment a voltage at any node of the resistance ladder 240 according to the control signal CNT.

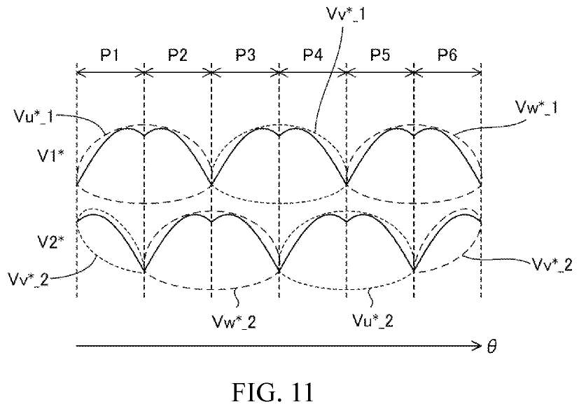

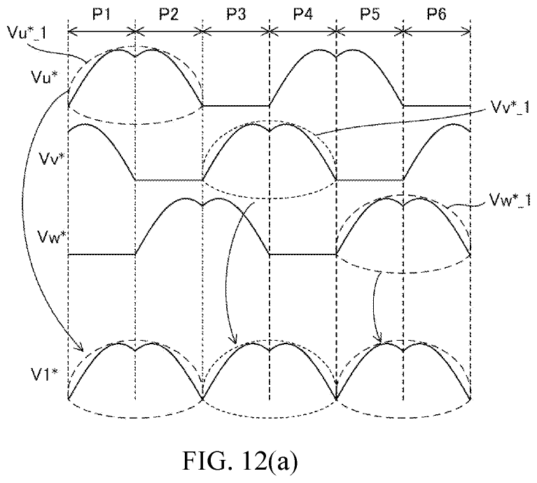

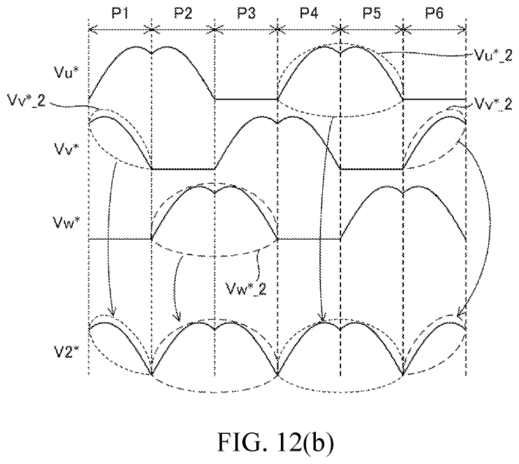

FIG. 11 shows waveforms of the command phase voltages V1* and V2*. Also referring to FIG. 12(a), the command phase voltage V1* is obtained by combining a voltage Vu*_1 equivalent to the target phase voltage Vu* in the periods P1 and P2, a voltage Vv*_1 equivalent to the target phase voltage Vv* in the periods P3 and P4, and a voltage Vw*_1 equivalent to the target phase voltage Vw* in the periods P5 and P6. That is to say, the command phase voltage V1* represents the target phase voltage Vu* (the phase voltage Vu to be supplied to the coil 2u) in the periods P1 and P2, the target phase voltage Vv* (the phase voltage Vv to be supplied to the coil 2v) in the periods P3 and P4, and the target phase voltage Vw* (the phase voltage Vw to be supplied to the coil 2w) in the periods P5 and P6. Also referring to FIG. 12(b), the command phase voltage V2* is obtained by combining a voltage Vw*_2 equivalent to the target phase voltage Vw* in the periods P2 and P3, a voltage Vu*_2 equivalent to the target phase voltage Vu* in the periods P4 and 1³5, and a voltage Vv*_2 equivalent to the target phase voltage Vv* in the periods P6 and P1. That is to say, the command phase voltage V2* represents the target phase voltage Vw* (the phase voltage Vw to be supplied to the coil 2w) in the periods P2 and P3, the target phase voltage Vu* (the phase voltage Vu to be supplied to the coil 2u) in the periods P4 and P5, and the target phase voltage Vv* (the phase voltage Vv to be supplied to the coil 2v) in the periods P6 and P1.

The comparator 25_1 compares the command phase signal V1* and the voltage Vtri and outputs a signal Spwm1 indicating a comparison result. More specifically, the command phase signal V1* is input to a non-inverting input terminal of the comparator 25_1, and the voltage Vtri is input to an inverting input terminal. The comparator 25_1 sets the signal Spwm1 to a high level when the command phase voltage V1* is higher than the voltage Vtri, and sets the signal Spwm1 to a low level when the command phase voltage V1* is lower than the voltage Vtri. When “V1*=Vtri”, the signal Spwm1 becomes a high level or a low level. The signal Spwm1 is a PWM signal obtained by performing PWM on the command phase voltage V1*, and is equivalent to the command phase voltage V1* that has undergone PWM.

The comparator 25_2 compares the command phase signal V2* and the voltage Vtri and outputs a signal Spwm2 indicating a comparison result. More specifically, the command phase signal V2* is input to a non-inverting input terminal of the comparator 25_2, and the voltage Vtri is input to an inverting input terminal. The comparator 25_2 sets the signal Spwm2 to a high level when the command phase voltage V2* is higher than the voltage Vtri, and sets the signal Spwm2 to a low level when the command phase voltage V2* is lower than the voltage Vtri. When “V2*=Vtri”, the signal Spwm2 becomes a high level or a low level. The signal Spwm2 is a PWM signal obtained by performing PWM on the command phase voltage V2*, and is equivalent to the command phase voltage V2* that has undergone PWM.

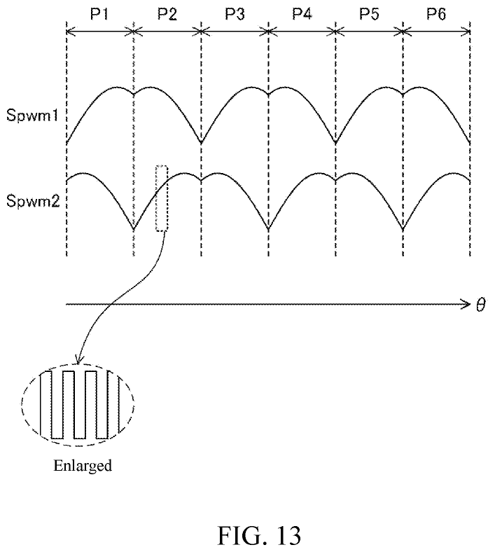

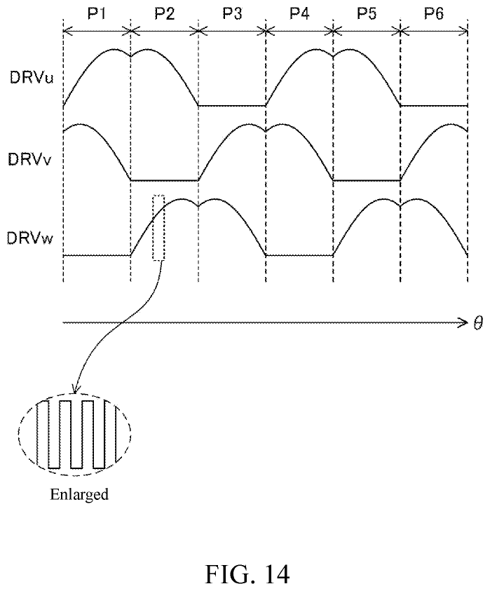

FIG. 13 in brief depicts waveforms of the signals Spwm1 and Spwm2. Although not explicitly shown in FIG. 13, the signals Spwm1 and Spwm2 undergo PWM with a period that is in fact sufficiently short compared to each of the periods P1 to P6. For better clarity in FIG. 13, the signals Spwm1 and Spwm2 are drawn as averaged signals. The average herein refers to an average relative to a PWM period (that is, a reciprocal of the PWM frequency).

The logic circuit 26 assigns two PWM signals, that is, the signals Spwm1 and Spwm2, to any two of the U phase, the V phase and the W phase according to the detection signals HALL_u, HALL_v and HALL_w. In addition, the logic circuit 26 generates and outputs the driving signals DRVu, DRVv and DRVw according to an assignment result, and thus implements the two-phase modulation.

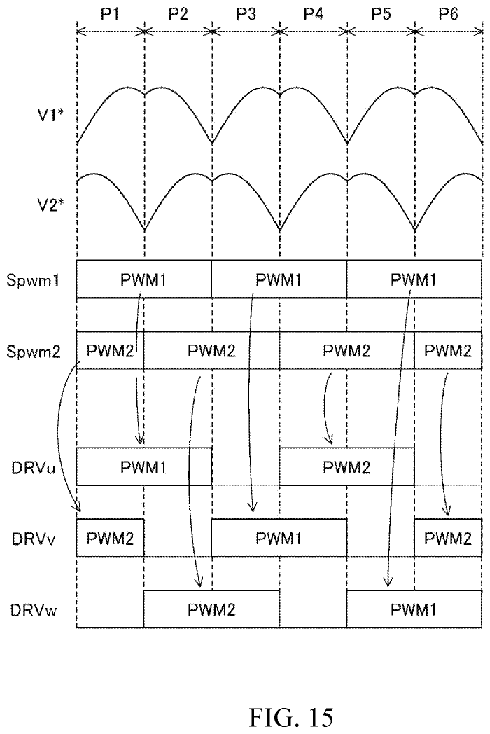

At this point in time, the logic circuit 26 assigns the signal Spwm1 to the first switching drive phase and the signal Spwm2 to the second switching drive phase according to the detection signals HALL_u, HALL_v and HALL_w, and assigns a predetermined fixed signal to the switching stop phase. More specifically, according to the detection signals HALL_u, HALL_v and HALL_w (also referring to FIG. 15), the logic circuit 26 sets the U phase and the V phase to be the first and second switching drive phases in the period P1, respectively, sets the U phase and the W phase to be the first and second switching drive phases in the period P2, respectively, sets the V phase and the W phase to be the first and second switching drive phases in the period P3, respectively, sets the V phase and the U phase to be the first and second switching drive phases in the period P4, respectively, sets the W phase and the U phase to be the first and second switching drive phases in the period P5, respectively, and sets the W phase and the V phase to be the first and second switching drive phases in the period P6, respectively.

Assigning the fixed signal to the switching stop phase refers to fixing the value of the driving signal corresponding to the phase as the switching stop phase among the U phase, the V phase and the W phase as “0”.

FIG. 14 shows waveforms of the driving signals DRVu, DRVv and DRVw output from the logic circuit 26 during the two-phase modulation. Although not explicitly shown in FIG. 14, it is assumed that when the U phase is set as the first or second switching drive phase, the driving signal DRVu undergoes PWM with a period that is in fact sufficiently short compared to each of the periods P1 to P6. For better clarity in FIG. 14, the driving signal DRVu is drawn as an averaged signal. The average herein refers to an average relative to a PWM period (that is, a reciprocal of the PWM frequency). The same applies to the driving signals DRVv and DRVw. Any one among the U phase, the V phase and the W phase that is not set as the first or second switching drive phase is set as the switching stop phase. Thus, the W phase is set as the switching stop phase in the periods P1 and P4, the V phase is set as the switching stop phase in the periods P2 and P5, and the U phase is set as the switching stop phase in the periods P3 and P6.

The signal Spwm1 is used as the driving signal DRVu and output in a period in which the U phase is set as the first switching drive phase, and the signal Spwm2 is used as the driving signal DRVu and output in a period in which the U phase is set as the second switching drive phase. The value of the driving signal DRVu is fixed at “0” in a period in which the U phase is set as the switching stop phase. The signal Spwm1 is used as the driving signal DRVv and output in a period in which the V phase is set as the first switching drive phase, and the signal Spwm2 is used as the driving signal DRVv and output in a period in which the V phase is set as the second switching drive phase. The value of the driving signal DRVv is fixed at “0” in a period in which the V phase is set as the switching stop phase. The signal Spwm1 is used as the driving signal DRVw and output in a period in which the W phase is set as the first switching drive phase, and the signal Spwm2 is used as the driving signal DRVw and output in a period in which the W phase is set as the second switching drive phase. The value of the driving signal DRVw is fixed at “0” in a period in which the W phase is set as the switching stop phase.

The driving signals DRVu, DRVv and DRVw output from the logic circuit 26 are supplied to the pre-driver 30 (referring to FIG. 4), and the phase voltages Vu, Vv and Vw formed based on the driving signals DRVu, DRVv and DRVw are output to the coils 2u, 2v and 2w by the pre-driver 30 and the inversion circuit 40.

That is to say, the pre-driver 30 and the inversion circuit 40 supply the first switching voltage based on the signal Spwm1 to the coil in the first switching drive phase and the second switching voltage based on the signal Spwm2 to the coil in the second switching drive phase, and supply a fixed voltage (a 0 V voltage herein) to the switching stop phase.

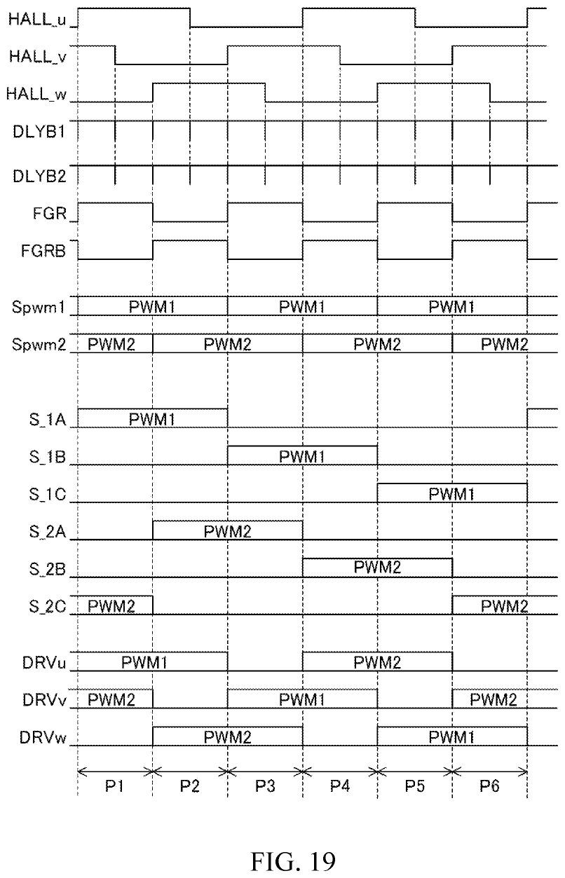

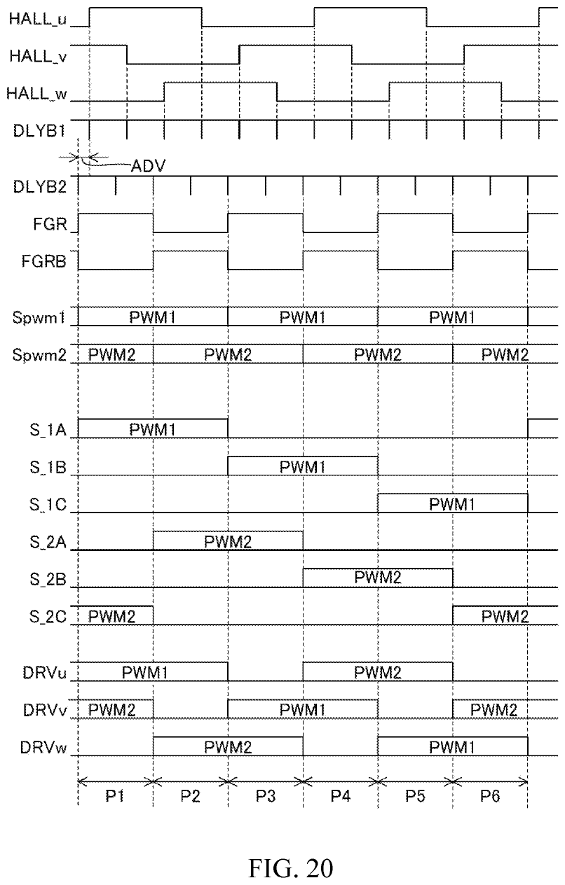

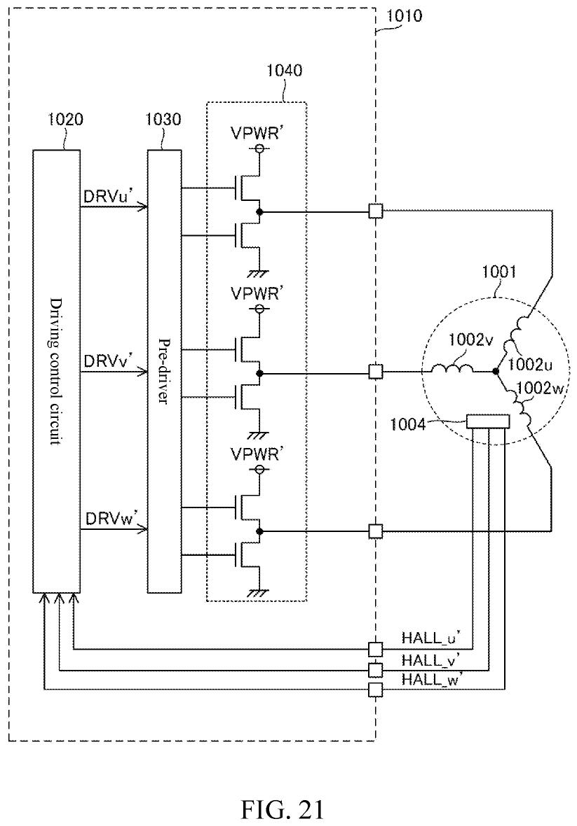

FIG. 15 shows relations of the periods P1 to P6, the command phase voltages V1* and V2*, the signals Spwm1 and Spwm2, and the driving signals DRVu, DRVv and DRVw. In FIG. 15, for better clarity, the PWM signal serving as the signal Spwm1 is denoted as “PWM1”, and the PWM signal serving as the signal Spwm2 is denoted as “PWM2” (the same applies to the description associated with FIG. 19 and FIG. 20 below).

The U phase and the V phase are set to be the first and second switching drive phases in the period P1, respectively. Thus, in the period P1, the signal Spwm1 is assigned to the driving signal DRVu, and as a result, the first switching voltage (first square wave voltage) obtained by performing PWM on the power supply voltage VPWR using the signal Spwm1 in the period P1 is used as the phase voltage Vu, and supplied to the coil 2u from the half-bridge circuit 40u. Moreover, in the period P1, the signal Spwm2 is assigned to the driving signal DRVv, and as a result, the second switching voltage (second square wave voltage) obtained by performing PWM on the power supply voltage VPWR using the signal Spwm2 in the period P1 is used as the phase voltage Vv, and supplied to the coil 2v from the half-bridge circuit 40v. Further, in the period P1, the half-bridge circuit 40w is fixed to an output low state because the value of the driving signal DRVw is fixed at “0”, and as a result, the phase voltage Vw is fixed at 0 V.

The U phase and the W phase are set to be the first and second switching drive phases in the period P2, respectively. Thus, in the period P2, the signal Spwm1 is assigned to the driving signal DRVu, and as a result, the first switching voltage (first square wave voltage) obtained by performing PWM on the power supply voltage VPWR using the signal Spwm1 in the period P2 is used as the phase voltage Vu, and supplied to the coil 2u from the half-bridge circuit 40u. Moreover, in the period P2, the signal Spwm2 is assigned to the driving signal DRVw, and as a result, the second switching voltage (second square wave voltage) obtained by performing PWM on the power supply voltage VPWR using the signal Spwm2 in the period P2 is used as the phase voltage Vw, and supplied to the coil 2w from the half-bridge circuit 40w. Further, in the period P2, the half-bridge circuit 40v is fixed to an output low state because the value of the driving signal DRVv is fixed at “0”, and as a result, the phase voltage Vv is fixed at 0 V.

The same applies to the periods P3 to P6.

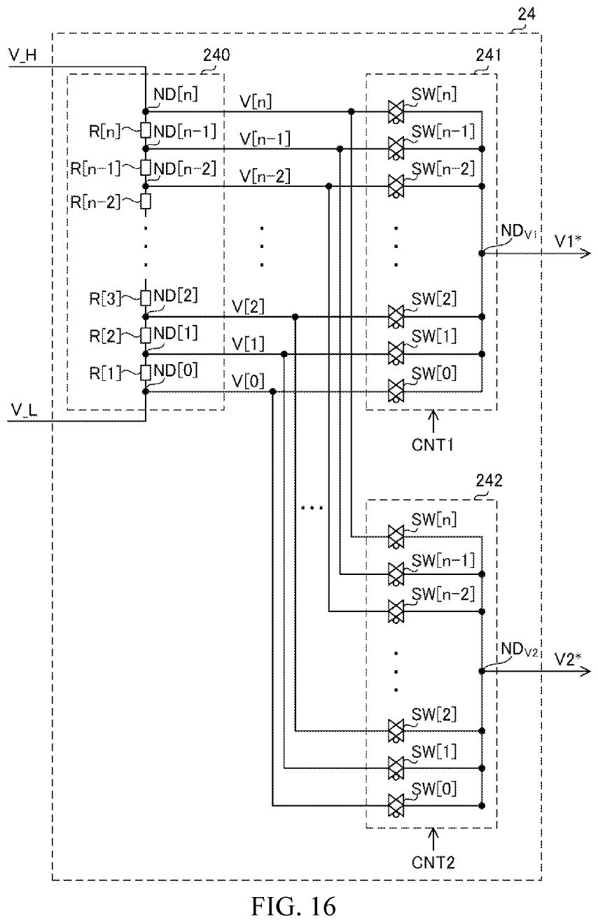

FIG. 16 shows a configuration example of the resistance ladder 240 and the switch circuits 241 and 242 of the DA converter 24. In the configuration example in FIG. 16, the resistance ladder 240 includes resistors R[1] to R[n], and the switch circuits 241 and 242 respectively include switches SW[0] to SW[n]. Each of the switches SW[0] to SW[n] is a bidirectional switch (bus switch). Wherein, n is an integer greater than 2, and is usually sufficiently greater than 2 (for example, n=256).

In the resistance ladder 240, the resistors R[1] to R[n] are connected in series to one another, and a predetermined DC voltage is applied to a series circuit of the resistors R[1] to R[n]. The DC voltage is equivalent to the voltage V H observed from the potential of the voltage V_L. Among the resistors R[1] to R[n], the resistor R[n] is arranged on a highest potential side, and the resistor R[1] is arranged on a lowest potential side. One terminal of the resistor R[n] is connected to a node ND[n], and the voltage V H is applied to the node ND[n]. One terminal of the resistor R[1] is connected to a node ND[0], and the voltage V_L is applied to the node ND[0]. For an arbitrary integer i that satisfies “1≤i≤(n−1)”, the resistor R[i+1] is arranged closer to the high potential side than the resistor R[i], and the resistors R[i+1] and R[i] are connected to each other by the node ND[i]. Voltages generated at the nodes ND[0] to ND[n] (in other words, voltages applied to the nodes ND[0] to ND[n]) are respectively referred to as voltages V[0] to V[n].

For an arbitrary integer i that satisfies “0 i ⁻n”, one terminal of the switch SW[i] of the switch circuit 241 is connected to the node ND[i], and one terminal of the switch SW[i] of the switch circuit 242 is also connected to the node ND[i]. Respective one other ends of the switches SW[0] to SW[n] of the switch circuit 241 are commonly connected using a node ND_{V1}, and respective one other ends of the switches SW[0] to SW[n] of the switch circuit 242 are commonly connected using a node ND_{V2}. A voltage applied to the node ND_{V1} is equivalent to the command phase voltage V1*, and a voltage applied to the node ND_{V2} is equivalent to the command phase voltage V2*.

A control signal CNT1 is input to the switch circuit 241, and a control signal CNT2 is input to the switch circuit 242. The control signal CNT from the control signal generator 22 (referring to FIG. 9) includes the control signals CNT1 and CNT2. The control signal CNT may be considered as being formed by the two control signals CNT1 and CNT2, or may be considered as including information of the control signals CNT1 and CNT2, and the control signal CNT is decoded by the DA converter 24 to generate the control signals CNT1 and CNT2. In sum, each of the control signals CNT1 and CNT2 is a corresponding signal formed by identifying the phase θ of the rotor 3 by the control signal generator 22.

The switch circuit 241 turns on only any one of the switches SW[0] to SW[n] in the switch circuit 241 according to the control signal CNT1, and turns off all the remaining switches. Thus, any one of the voltages V[0] to V[n] of the nodes ND[0] to ND[n] is applied to the node ND_{V1}By applying the voltage V[i] to the node ND_{V1} at the moment at which the switch SW[i] in the switch circuit 241 is turned on, “V1*=V[i]” is established (where i is an integer that satisfies “0≤i≤n”).

The switch circuit 242 turns on only any one of the switches SW[0] to SW[n] in the switch circuit 242 according to the control signal CNT2, and turns off all the remaining switches. Thus, any one of the voltages V[0] to V[n] of the nodes ND[O] to ND[n] is applied to the node ND_{V2}. By applying the voltage V[i] to the node ND_{V2} at the moment at which the switch SW[i] in the switch circuit 242 is turned on, “V2^{*}=V[i]” is established (where i is an integer that satisfies “0≤i≤n”).

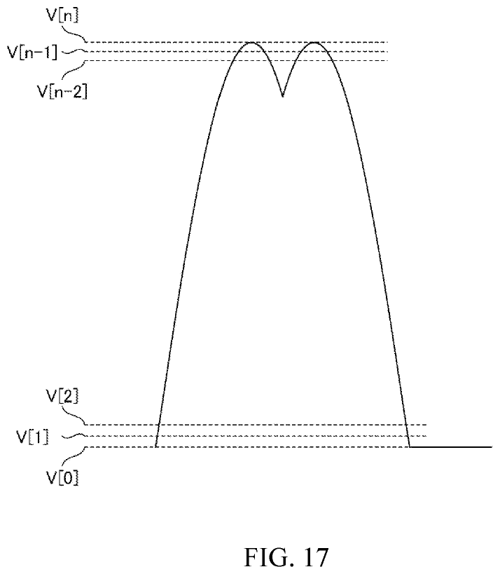

In FIG. 17, in the relations of the voltage waveforms similar to the waveform of the target phase voltage Vu*, Vv*, or Vw*, some of the voltages V[0] to V[n] are shown. Voltages with a total of (n−1) boundaries formed by partitioning a voltage range (referring to FIG. 8) from the minimum voltage V_{BTM} to the maximum voltage V_{TOP} into n partitions correspond to the voltages V[1] to V[n−1], and the voltages V_{BTM} and V_{TOP} respectively correspond to the voltages V[0] and V[n]. The partitioning into then partitions may be equal partitioning or non-equal partitioning.

As such, the switch circuit 241 selects any one of the voltages V[0] to V[n] according to the control signal CNT (CNT1) to generate the command phase voltage V1*, and the switch circuit 242 selects any one of the voltages V[0] to V[n] according to the control signal CNT (CNT2) to generate the command phase voltage V2*. Since the control signal CNT changes constantly as the phase θ of the rotor 3 changes with the rotation of the rotor 3, each switch that is turned on in the switch circuits 241 and 242 also changes in order. As a result, the command phase voltages V1* and V2* as shown in FIG. 11 are obtained. In other words, the control signal CNT is generated according to the detection signal HALL X and input to the DA converter 24 in order to output the command phase voltages V1* and V2* having characteristics shown in FIG. 11 from the switch circuits 241 and 242.

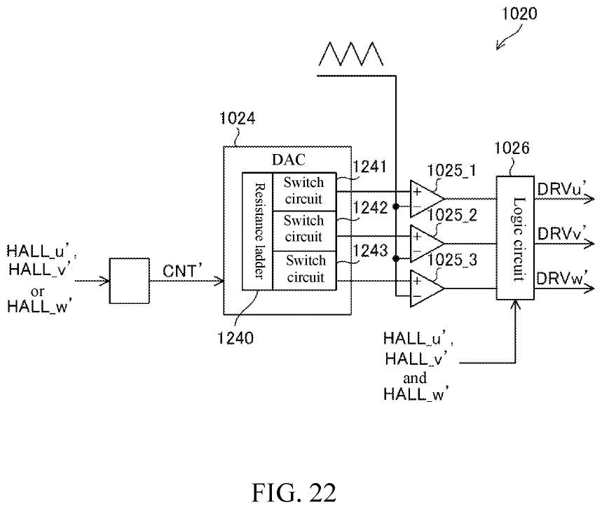

Compared to the configuration in FIG. 22, the configuration according to this embodiment is capable of omitting a switch circuit of one phase and a comparator of one phase, and is capable of significantly reducing the circuit size of a driver IC.

In the multiple embodiments below, some specific configuration examples, operation examples, application techniques and variation techniques with respect to the motor driving system above are described. Unless otherwise specified and without any contradiction, the items in this embodiment are applicable to the various embodiments below. In the various embodiments, the description of the embodiments may also be overruling in the presence of any items contradictory from the items described above. Provided there are not contradictions, the items described in any one of the embodiments below are also applicable to other embodiments (that is to say, any two or more of the embodiments can be combined).

### First Embodiment

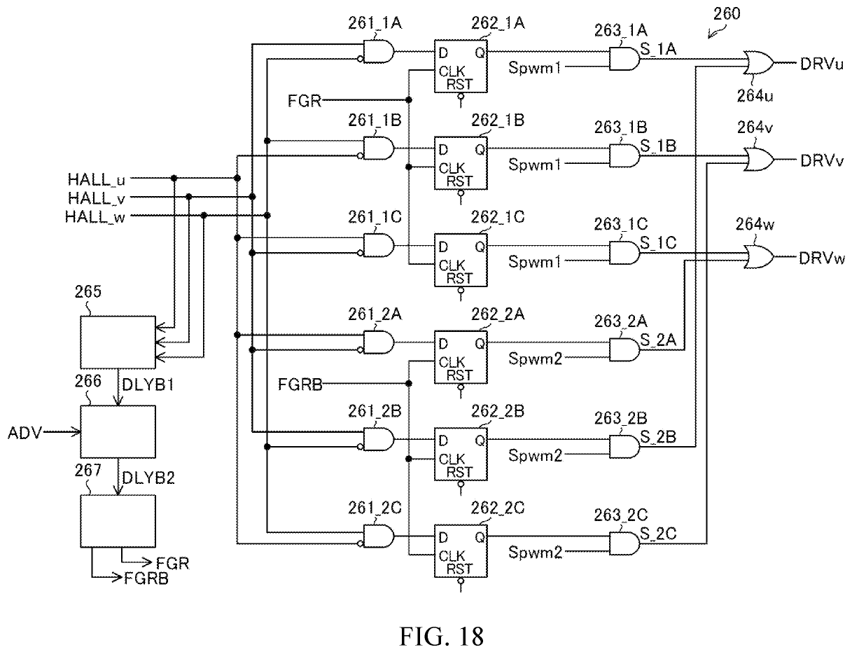

A first embodiment is described. FIG. 18 shows a circuit diagram of a driving signal generator 260 of the first embodiment. The driving signal generator 260 may be arranged in the logic circuit 26 in FIG. 9. The driving signal generator 260 includes AND circuits 261_1A to 261_1C and 261_2A to 261_2C, flip-flops 262_1A to 262_1C and 262_2A to 262_2C, AND circuits 263_1A to 263_1C and 263_2A to 263_2C, OR circuits 264u, 264v and 264w, and circuits 265 to 267. In the driving signal generator 260, the driving signals DRVu, DRVv and DRVw at a high level are equivalent to the driving signals DRVu, DRVv and DRVw in a value of “1”, and the driving signals DRVu, DRVv and DRVw at a low level are equivalent to the driving signals DRVu, DRVv and DRVw in a value of “0”.

FIG. 19 shows a timing diagram related to the operations of the driving signal generator 260, and FIG.19 indicates waveforms of internal signals and input/output signals of the driving signal generator 260. Although an advance angle control can be performed in the driver IC 10, it is assumed that the advance angle control is not performed in the first embodiment, and FIG. 19 shows waveforms when the advance angle control is not performed. Each of signals DLYB1, DLYB2, FGR and FGRB is a binary signal that has the signal level of either a high level or a low level.

The circuit 265 generates the signal DLYB1 according to the detection signals HALL_u, HALL_v and HALL_w. The signal DLYB1 is in principle at a high level. The circuit 265 sets the signal DLYB1 at a low level only in a minute time synchronous with an upper edge if any one of the detection signals HALL_u, HALL_v and HALL _w generates the upper edge, and sets the signal DLYB1 at a low level only in a minute time synchronous with a lower edge if any one of the detection signals HALL_u, HALL_v and HALL_w generates the lower edge. Thus, a lower edge is generated at the signal DLBY1 once the phase θ of the rotor 3 advances by an electric angle of 60°.

The circuit 266 generates the signal DLBY2 by progressing the phase of the signal DLYB1 only by an advance angle value ADV. The advance angle value ADV is an amount of an angle, and has a value more than 0. Herein, it is assumed that the advance angle value ADV is zero (that is, no advance angle control is performed), and so the signal DLYB2 is the same as the signal DLYB1.

The circuit 267 generates the signals FGR and FGRB according to the signal DLYB2. The circuits 267 has, by using the signal DLYB2, the level of the signal FGR alternate between a high level and a low level for every two lower edge generated. However, a moment of an upper edge of the signal FGR synchronous with an “odd-number-th” upper edge of the detection signal HALL_u is equivalent to the starting moment of the period P1, and a moment of a lower edge of the signal FGR synchronous with an “even-number-th” upper edge of the detection signal HALL_u is equivalent to the starting moment of the period P4. The signal FGRB is an inverted signal of the signal FGR.

The AND circuit 261_1A outputs a logical product signal of the detection signal HALL_v and an inverted signal of the detection signal HALL_w. Thus, an output signal of the AND circuit 261 lA is at a high level only in a period in which the signals HALL_v and HALL_w are respectively at a high level and a low level, and is at a low level in other periods. The AND circuit 261_1B outputs a logical product signal of the detection signal HALL_w and an inverted signal of the detection signal HALL_u. Thus, an output signal of the AND circuit 261_1B is at a high level only in a period in which the signals HALL_w and HALL_u are respectively at a high level and a low level, and is at a low level in other periods. The AND circuit 261_1C outputs a logical product signal of the detection signal HALL_u and an inverted signal of the detection signal HALL_v. Thus, an output signal of the AND circuit 261_1C is at a high level only in a period in which the signals HALL_u and HALL_v are respectively at a high level and a low level, and is at a low level in other periods.

The AND circuit 261_2A outputs a logical product signal of the detection signal HALL_u and an inverted signal of the detection signal HALL_v. Thus, an output signal of the AND circuit 261_2A is at a high level only in a period in which the signals HALL_u and HALL_v are respectively at a high level and a low level, and is at a low level in other periods. The AND circuit 261_2B outputs a logical product signal of the detection signal HALL_v and an inverted signal of the detection signal HALL_w. Thus, an output signal of the AND circuit 261_2B is at a high level only in a period in which the signals HALL_v and HALL_w are respectively at a high level and a low level, and is at a low level in other periods. The AND circuit 261_2C outputs a logical product signal of the detection signal HALL_w and an inverted signal of the detection signal HALL_u. Thus, an output signal of the AND circuit 261_2C is at a high level only in a period in which the signals HALL_w and HALL _u are respectively at a high level and a low level, and is at a low level in other periods.

Each of flip-flops 262_1A to 262_1C and 262_2A to 262_2C is a positive trigger type D flip-flop, and includes a data input terminal (D), a clock input terminal (CLK), an output terminal (Q), and a negative logic reset input terminal (RST). For illustration purposes, any positive trigger type D flip-flop is referred to as a reference DFF, and operations of the reference DFF are described. Similar to the flip-flop 262_1A, the reference DFF includes a data input terminal (D), a clock input terminal (CLK), an output terminal (Q), and a negative logic reset input terminal (RST). The description of the reference DFF is applied to each of flip-flops 262_1A to 262_1C and 262_2A to 262_2C. An output signal of the reference DFF is derived from the output terminal (Q) of the reference DFF. The reference DFF is kept at a value (logical value) of “0” or “1”, and sets the output signal thereof to a low level when kept at the value of “0” and to a high level when kept at a value of “1”. In the reference DFF, an upper edge is generated in an input signal of the clock input terminal (CLK) under the premise that an the input signal of the reset input terminal (RST) is at a high level and is synchronous with the same at this point in time, a holding value thereof is set to “1” if the input signal to the data input terminal (D) is at a high level, and the holding value thereof is set to “0” if the input signal to the data input terminal (D) is at a low level. In the reference DFF, setting the input signal to the reset input terminal (RST) to a low level is referred to as data reset. In the reference DFF, the holding value is set to “0” by data reset.

Output signals of the AND circuits 261_1A, 261_1B, 261_1C, 261_2A, 261_2B and 261_2C are respectively input to the data input terminals (D) of the flip-flips 262_1A, 262_1B, 262_1C, 262_2A, 262_2B and 262_2C. The signal FGR is input to the clock input terminals (CLK) of the flip-flops 262_1A, 262_1B and 262_1C, and the signal FGRB is input to the clock input terminals (CLK) of the flip-flops 262_2A, 262_2B and 262_2C.

In the driving signal generator 260, in order to generate data reset by the flip-flop 262_1A when an upper edge is generated in the output signal of the flip-flop 262_1B or 262_1C, to generate data reset by the flip-flop 262_1B when an upper edge is generated in the output signal of the flip-flop 261 1C or 262_1A, and to generate data reset by the flip-flop 262_1C when an upper edge is generated in the output signal of the flip-flop 262_1A or 262_1B, a signal is input to the reset input terminals (RST) of the flip-flops 262_1A, 262_1B and 262_1C. For example, inverted signals of the output signals of the flip-flops 262_1B, 262_1C and 262_1A may also be input to the reset input terminals (RST) of the flip-flops 262_1A, 262_1B and 262_1C, respectively.

In the driving signal generator 260, in order to generate data reset by the flip-flop 262_2A when an upper edge is generated in the output signal of the flip-flop 262_2B or 262_2C, to generate data reset by the flip-flop 262_2B when an upper edge is generated in the output signal of the flip-flop 262_2C or 262_2A, and to generate data reset by the flip-flop 262_2C when an upper edge is generated in the output signal of the flip-flop 262_2A or 262_2B, a signal is input to the reset input terminals (RST) of the flip-flops 262_2A, 262_2B and 262_2C. For example, inverted signals of the output signals of the flip-flops 262_2B, 262_2C and 262_2A may also be input to the reset input terminals (RST) of the flip-flops 262_2A, 262_2B and 262_2C, respectively.

Moreover, when an upper edge is generated in the signal FGR in synchronization with the upper edge of the detection signal HALL_u, HALL _v or HALL_w, in order to determine the input signal to the data input terminals (D) of the flip-flops 262_1A to 262_1C according to the detection signals HALL_u, HALL_v and HALL_w before the moment of the upper edge of the signal FGR, the driving signal generator 260 is formed. Thus, for example, when an upper edge is generated at the signal FGR in synchronization with the upper edge of the detection signal HALL_u, because the detection signals HALL_u, HALL_v and HALL_w are respectively at a low level, a high level and a low level before the moment of the upper edge of the signal FGR, among the flip-flops 262_1A to 262_1C, only the input signal to the data input terminal (D) of the flip-flop 262_1A is identified as being at a high level and only the output signal of the flip-flop 262_1A is at a high level. Moreover, when an upper edge is generated in the signal FGRB in synchronization with the upper edge of the detection signal HALL_u, HALL_v or HALL_w, in order to determine the input signal to the data input terminals (D) of the flip-flops 262_2A to 262_2C according to the detection signals HALL_u, HALL_v and HALL_w before the moment of the upper edge of the signal FGRB, the driving signal generator 260 is formed. Thus, for example, when an upper edge is generated at the signal FGRB in synchronization with the upper edge of the detection signal HALL_w, because the detection signals HALL_u, HALL_v and HALL_w are respectively at a high level, a low level and a high level before the moment of the upper edge of the signal FGRB, among the flip-flops 262_2A to 262_2C, only the input signal to the data input terminal (D) of the flip-flop 262_2A is identified as being at a high level and only the output signal of the flip-flop 262_2A is at a high level.

The AND circuit 263_1A outputs a logical product signal S_1A of the output signal of the flip-fop 262_1A and the signal Spwm1. Thus, the output signal S_1A of the AND circuit 263_1A only is at a high level in a period in which both the output signal of the flip-flop 262_1A and the signal Spwm1 are at a high level, and is at a low level in other periods. The AND circuit 263_1B outputs a logical product signal S_1B of the output signal of the flip-flop 262_1B and the signal Spwm1. Thus, the output signal S_1B of the AND circuit 263_1B only is at a high level in a period in which both the output signal of the flip-flop 262_1B and the signal Spwm1 are at a high level, and is at a low level in other periods. The AND circuit 263_1C outputs a logical product signal S_1C of the output signal of the flip-flop 262_1C and the signal Spwm1. Thus, the output signal S_1C of the AND circuit 263_1C only is at a high level in a period in which both the output signal of the flip-flop 262_1C and the signal Spwm1 are at a high level, and is at a low level in other periods.

The AND circuit 263_2A outputs a logical product signal S_2A of the output signal of the flip-flop 262_2A and the signal Spwm2. Thus, the output signal S_2A of the AND circuit 263_2A only is at a high level in a period in which both the output signal of the flip-flop 262_2A and the signal Spwm2 are at a high level, and is at a low level in other periods. The AND circuit 263_2B outputs a logical product signal S_2B of the output signal of the flip-flop 262_2B and the signal Spwm2. Thus, the output signal S_2B of the AND circuit 263_2B only is at a high level in a period in which both the output signal of the flip-flop 262_2B and the signal Spwm2 are at a high level, and is at a low level in other periods. The AND circuit 263_2C outputs a logical product signal S_2C of the output signal of the flip-flop 262_2C and the signal Spwm2. Thus, the output signal S_2C of the AND circuit 263_2C only is at a high level in a period in which both the output signal of the flip-flop 262_2C and the signal Spwm2 are at a high level, and is at a low level in other periods.

The OR circuit 264u outputs a logical sum signal of the output signal S lA and the signal S_2B as the driving signal DRVu. Thus, the driving signal DRVu is at a high level if at least one of the signals S lA and S 2B is at a high level, and is at a low level if both the signals S_1A and S_2B are at a low level. The OR circuit 264v outputs a logical sum signal of the output signal S 1B and the signal S_2C as the driving signal DRVv. Thus, the driving signal DRVv is at a high level if at least one of the signals S_1B and S_2C is at a high level, and is at a low level if both the signals S 1B and S 2C are at a low level. The OR circuit 264w outputs a logical sum signal of the output signal S_1C and the signal S_2A as the driving signal DRVw. Thus, the driving signal DRVw is at a high level if at least one of the signals S_1C and S_2A is at a high level, and is at a low level of both the signals S_1C and S_2A are at a low level.

The moments of the upper edges of the output signals of the flip-flop 262_1A, the flip-flop 262_2A, the flip-flop 262_1B, the flip-flop 262_2B, the flip-flop 262_1C and the flip-flop 262_2C are respectively equivalent to the starting moments of the periods Pl, P2, P3, P4, P5 and P6.

As such, the driving signal generator 260 in the logic circuit 26 generates, according to the detection signals HALL_u, HALL_v and HALL_w, and switches the phase to be assigned to the signals Spwm1 and Spwm2 among the U phase, the V phase and the W phase when the signal level of an internal signal (FGR, FGRB) changes, wherein the signal level of the internal signal changes each time when the phase θ of the rotor 3 changes by an electric angle of 120°. For better understanding from the circuit configuration in FIG. 18, the phase to be assigned is determined according to the detection signals HALL_u, HALL_v and HALL_w. For example, when an upper edge is generated in the signal FGR in a period in which the detection signal HALL_v is at a high level and the detection signal HALL_w is at a low level, switching is performed to the U phase to be assigned to the signal Spwm1.

### Second Embodiment

A second embodiment is described. In this embodiment, although the advance angle control is neglected (that is to say, it is assumed the advance angle value ADV is zero) in the description up to the current point in time, the advance angle control may also be performed in the driver IC 10. It is assumed that the advance angle control is performed in the second embodiment.

When the advance angle control is performed, the driving signal generator 260 in FIG. 18 is used, and the advance angle value ADV is set to a positive value. FIG. 20 shows a timing diagram related to the operations of the driving signal generator 260 when the advance angle control is performed, and FIG. 20 indicates waveforms of internal signals and input/output signals of the driving signal generator 260. The driving signal generator 260 implements the advance angle control by providing a phase difference of the advance angle value ADV between the detection signals HALL_u, HALL_v and HALL_w and the internal signal (FGR and FGRB).

The advance angle value ADV may have a fixed value, or the advance angle value ADV may be set according to a signal input to the driver IC 10 from an external device (not shown) of the driver IC 10. Alternatively, the advance angle value ADV may be set according to a rotational speed of the motor 1, or the advance angle value ADV may be set according to a torque command signal specifying a torque to be generated by the motor 1.

When the advance angle control is performed, the starting moment of the period P1 is shifted by the advance angle value from the moment of the upper edge of the detection signal HALL_u. The same applies to situations between the starting moments of the periods P2 to P6 and the moment of the upper edge of the detection signal HALL_u, HALL_v or HALL_w. Thus, the control signal CNT is generated with consideration of the advance angle value ADV. That is to say, for example, if the detection signal HALL_X in FIG. 9 is the detection signal HALL_u, the control signal generator 22 generates the control signal CNT according to only the detection signal HALL_u and the advance angle value ADV, such that the command phase voltage V1* rises from the minimum voltage V_{BTM} at a moment advanced from the upper edge of the detection signal HALL_u by the advance angle value ADV (setting the command phase voltage V2* to delay only by an electric angle of 120° relative to the command phase voltage V1*).

### Third Embodiment

A third embodiment is described. In the third embodiment, some application techniques and variation techniques with respect to the configurations or operations above are described.

In general, during a two-phase modulation, the phase voltage of a coil of a switching stop phase is fixed to a power supply voltage or a ground voltage. In the embodiment above, although an example in which the half-bridge circuit corresponding to the switching stop phase is fixed to an output low state is given, a variation may be made to the driver IC 10 by fixing the half-bridge circuit corresponding to the switching stop phase to an output high state, as a substitution. In this case, the power supply voltage VPWR is supplied to the coil of the switching stop phase as a fixed voltage (that is to say, the phase voltage of the coil of the switching stop phase is fixed by the power supply voltage VPWR). For example, the phase voltage Vu is fixed at the power supply voltage VPWR in a period in which the U phase is set to the switching stop phase.

For the FETs in the various embodiments, the types of channels are only exemplary, and the N-channel FET may be modified to the P-channel FET, or the P-channel FET may be modified to the N-channel FET, so as to modify the circuit structure including the FET.

Given that no inappropriateness is incurred, an arbitrary transistor may also be any type of transistor. For example, given that no inappropriateness is incurred, an arbitrary transistor implemented by a MOSFET may be replaced by a junction FET, an insulated gate bipolar transistor (IGBT) or a bipolar transistor. An arbitrary transistor includes a first electrode, a second electrode and a control electrode. In a FET, one of the first and second electrodes is the drain and the other is the source, and the control electrode is the gate. In an IGBT, one of the first and second electrodes is the collector and the other is the emitter, and the control electrode is the gate. For a bipolar transistor that is not an IGBT, one of the first and second electrodes is the collector and the other is the emitter, and the control electrode is the base.

For an arbitrary signal or voltage, the relation between the high level and the low level may be opposite to the relation described, provided that the form of the subject matter is not compromised.

Various modifications may be made to the embodiments of the present disclosure within the scope of the technical concept of the claims. The embodiments above are only examples of possible implementations of the present disclosure, and the meanings of the terms of the constituting components of the present disclosure are not limited to the meanings of the terms used in the embodiments above. The specific numerical values used in the description are only examples, and these numerical values may be modified to various other numerical values.

1. A motor driving device, which drives a three-phase motor having coils with a U phase, a V phase and a W phase by a two-phase modulation, comprising:
a control signal generator, identifying a position of a rotor based on a position detection signal of the rotor of the three-phase motor, and outputting a digital control signal according to the position;
a DA converter, including a resistance ladder having a series circuit of a plurality of resistors, wherein the resistance ladder is used to, based on the control signal, generate analog first and second command phase voltages that represent phase voltages to be supplied to the coils of two of the U, V and W phases;
a periodic voltage generator, generating an analog periodic voltage with a voltage value that fluctuates periodically;
a first comparator, generating a first PWM signal by comparing the analog first command phase voltage and the analog periodic voltage;
a second comparator, generating a second PWM signal by comparing the analog second command phase voltage and the analog periodic voltage; and
a logic circuit, implementing the two-phase modulation by assigning the first and second PWM signals to any two of the U, V and W phases based on the position detection signal.

2. The motor driving device of claim 1, wherein
a plurality of voltages are generated at a plurality of nodes in the resistance ladder by applying a predetermined DC voltage to the series circuit,
the DA converter includes a first switch circuit connected to the plurality of nodes and a second switch circuit connected to the plurality of nodes, and
the first switch circuit generates the first command phase voltage by selecting one of the plurality of voltages based on the control signal, and the second switch circuit generates the second command phase voltage by selecting one of the plurality of voltages based on the control signal.

3. The motor driving device of claim 1, further comprising:
an output stage circuit, wherein the logic circuit, based on the position detection signal, assigns the first and second PWM signals to any two of the U, V and W phases as a first switching drive phase and a second switching drive phase, and assigns a fixed signal to one remaining phase as a switching stop phase, and wherein
the output stage circuit follows an output signal from the logic circuit based on an assignment result of the logic circuit, and
a first switching voltage and a second switching voltage which are based on the first and second PWM signals are supplied to the coils of the first and second switching drive phases, and a fixed voltage is supplied to the coil of the switching stop phase.

4. The motor driving device of claim 2, further comprising:
an output stage circuit, wherein the logic circuit, based on the position detection signal, assigns the first and second PWM signals to any two of the U, V and W phases as a first switching drive phase and a second switching drive phase, and assigns a fixed signal to one remaining phase as a switching stop phase, and wherein
the output stage circuit follows an output signal from the logic circuit based on an assignment result of the logic circuit, and
a first switching voltage and a second switching voltage which are based on the first and second PWM signals are supplied to the coils of the first and second switching drive phases, and a fixed voltage is supplied to the coil of the switching stop phase.

5. The motor driving device of claim 3, wherein
when the rotor rotates in the two-phase modulation, a first period, a second period, a third period, a fourth period, a fifth period and a sixth period are repeatedly accessed in such order, and wherein
the first command phase voltage represents:
a phase voltage to be supplied to the coil of the U phase in the first period and the second period,
a phase voltage to be supplied to the coil of the V phase in the third period and the fourth period, and
a phase voltage to be supplied to the coil of the W phase in the fifth period and the sixth period,
the second command phase voltage represents:
a phase voltage to be supplied to the coil of the W phase in the second period and the third period,
a phase voltage to be supplied to the coil of the U phase in the fourth period and the fifth period, and
a phase voltage to be supplied to the coil of the V phase in the sixth period and the first period, and wherein in the logic circuit,
the U phase and the V phase are respectively set to be the first and second switching drive phases in the first period,
the U phase and the W phase are respectively set to be the first and second switching drive phases in the second period,
the V phase and the W phase are respectively set to be the first and second switching drive phases in the third period,
the V phase and the U phase are respectively set to be the first and second switching drive phases in the fourth period,
the W phase and the U phase are respectively set to be the first and second switching drive phases in the fifth period, and
the W phase and the V phase are respectively set to be the first and second switching drive phases in the sixth period.

6. The motor driving device of claim 4, wherein
when the rotor rotates in the two-phase modulation, a first period, a second period, a third period, a fourth period, a fifth period and a sixth period are repeatedly accessed in such order, and wherein
the first command phase voltage represents:
a phase voltage to be supplied to the coil of the U phase in the first period and the second period,
a phase voltage to be supplied to the coil of the V phase in the third period and the fourth period, and
a phase voltage to be supplied to the coil of the W phase in the fifth period and the sixth period,
the second command phase voltage represents:
a phase voltage to be supplied to the coil of the W phase in the second period and the third period,
a phase voltage to be supplied to the coil of the U phase in the fourth period and the fifth period, and
a phase voltage to be supplied to the coil of the V phase in the sixth period and the first period, and wherein in the logic circuit,
the U phase and the V phase are respectively set to be the first and second switching drive phases in the first period,
the U phase and the W phase are respectively set to be the first and second switching drive phases in the second period,
the V phase and the W phase are respectively set to be the first and second switching drive phases in the third period,
the V phase and the U phase are respectively set to be the first and second switching drive phases in the fourth period,
the W phase and the U phase are respectively set to be the first and second switching drive phases in the fifth period, and
the W phase and the V phase are respectively set to be the first and second switching drive phases in the sixth period.

7. The motor driving device of claim 5, wherein
the position detection signal includes a first detection signal, a second detection signal and a third detection signal, and a phase of the rotor representing the position of the rotor is specified by the first to third detection signals in increments of an electric angle of 60°, and wherein
each of the first to sixth periods has a length corresponding to a change in the phase of the rotor by an electric angle of 120°, and wherein
the logic circuit, based on the first to third detection signals, generates an internal signal whose signal level changes each time when the phase of the rotor changes by an electric angle of 120°, and
when the signal level of the internal signal changes, the phase to be assigned to the first and second PWM signals is switched between the U phase, the V phase and the W phase,
and the phase to be assigned is determined based on the first to third detection signals.

8. The motor driving device of claim 6, wherein
the position detection signal includes a first detection signal, a second detection signal and a third detection signal, and a phase of the rotor representing the position of the rotor is specified by the first to third detection signals in increments of an electric angle of 60°, and wherein
each of the first to sixth periods has a length corresponding to a change in the phase of the rotor by an electric angle of 120°, and wherein
the logic circuit, based on the first to third detection signals, generates an internal signal whose signal level changes each time when the phase of the rotor changes by an electric angle of 120°, and
when the signal level of the internal signal changes, the phase to be assigned to the first and second PWM signals is switched between the U phase, the V phase and the W phase,
and the phase to be assigned is determined based on the first to third detection signals.

9. The motor driving device of claim 7, wherein advance angle control is executable in the motor driving device, and
the logic circuit implements an advance angle control by providing a phase difference corresponding to an advance angle value between the first to third detection signals and the internal signal.

10. The motor driving device of claim 8, wherein advance angle control is executable in the motor driving device, and
the logic circuit implements advance angle control by providing a phase difference corresponding to an advance angle value between the first to third detection signals and the internal signal.

11. The motor driving device of claim 7, wherein each of the first to third detection signals is a binary signal.

12. The motor driving device of claim 8, wherein each of the first to third detection signals is a binary signal.

13. The motor driving device of claim 9, wherein each of the first to third detection signals is a binary signal.

14. The motor driving device of claim 10, wherein each of the first to third detection signals is a binary signal.

15. The motor driving device of claim 2, further comprising a reference voltage generator to which a power supply voltage is an input and a signal for determining an amplitude of the analog periodic voltage is an output to the periodic voltage generator.

16. The motor driver device of claim 15, wherein the reference voltage generator outputs the predetermined DC voltage applied to the resistance ladder.

17. The motor driving device of claim 16, wherein the reference voltage generator outputs a first DC voltage and a second DC voltage lower than the first DC voltage, and the predetermined DC voltage is a difference between the first DC voltage and the second DC voltage.
